(19) United States
(12) Patent Application Publication
(10) Pub. No.: US 2014/0063001 A1
(43) Pub. Date: Mar. 6, 2014

(54) ACTIVE BARRIER PANEL AND THREE DIMENSIONAL IMAGE DISPLAY APPARATUS HAVING THE SAME

(71) Applicant: SAMSUNG DISPLAY CO., LTD, Yongin-City (KR)

(72) Inventors: Kwan-Ho KIM, Yongin-si (KR); Goro Hamagishi, Hwaseong-si (KR); Seung-Jun Yu, Suwon-si (KR); Sang-Min Jeon, Yongin-si (KR); Jae-Woo Jung, Cheonan-si (KR); Jung-Hyun Cho, Suwon-si (KR)

(73) Assignee: Samsung Display Co., LTD, Yongin-City (KR)

(21) Appl. No.: 13/742,074

(22) Filed: Jan. 15, 2013

(30) Foreign Application Priority Data
Aug. 30, 2012 (KR) 10-2012-0095885

(51) Int. Cl. G02F 1/13; G06T 15/00

(52) U.S. Cl. CPC G02F 1/1313; G06T 15/00
USPC 345/419; 349/1; 349/15

(57) ABSTRACT

An active barrier panel includes a first substrate, a second substrate and a liquid crystal layer. The first substrate includes a first opening electrode configured to operate as a first opening transmitting the light and a first barrier electrode configured to as a first barrier blocking the light, the first opening electrode and the first barrier electrode having a step structure. The second substrate includes a second opening electrode configured to operate as a second opening and crossing at a right angle to the first opening electrode, and a second barrier electrode configured to operate as a second barrier and crossing at a right angle to the first barrier electrode. The liquid crystal layer is disposed between the first and second substrates.

This application claims priority from and the benefit of Korean Patent Application No. 10-2012-0095885, filed on Aug. 30, 2012, which is hereby incorporated by reference for all purposes as if fully set forth herein.

### BACKGROUND OF THE INVENTION

1. Field of the Invention

Exemplary embodiments of the present invention relate to an active barrier panel and a display apparatus including the active barrier panel. More particularly, exemplary embodiments of the present invention relate to an active barrier panel capable of pivoting and a display apparatus including the active barrier panel.

2. Description of the Related Art

Generally, liquid crystal display apparatuses display two dimensional planar images. Recently, as consumers' need to display three dimensional stereoscopic images increases in various industry fields, such as game, movie, etc., liquid crystal display apparatuses that can display three dimensional stereoscopic images are being developed to meet the consumers' needs.

Generally, three-dimensional (“3D”) stereoscopic images are displayed by using a principle of binocular parallax through human eyes. For example, images observed from different angles through each eye are input to human brain of a viewer because human eyes are spaced apart for a desired distance. The stereoscopic image displaying apparatus use the principle of binocular parallax.

There are two general methods of displaying three-dimensional images using the binocular parallax: stereoscopic types (“glasses types”) and autostereoscopic types (“no-glasses types”). The stereoscopic method, which employs glasses, may use either polarization glasses or shutter glasses. The auto-stereoscopic method, which is done without glasses, may employee lenticular lenses, a barriers, liquid crystal lenses, liquid crystal barriers, and so on.

Recently, the use of a portable display apparatus is growing so that the portable display apparatus is configured to display the 3D stereoscopic image. Due to the nature of the portable display apparatus, the portable display apparatus is more conveniently used with a no-glasses type of three-dimensional display, rather than the glasses type of three dimensional display, which requires glasses.

### BRIEF SUMMARY OF THE INVENTION

An active barrier panel that is pivotable is provided.

A display apparatus including the active barrier panel is also provided.

According to one aspect, there is provided an active barrier panel selectively transmitting light emitted from a plurality of sub-pixels included in a unit-pixel of a display panel. The active barrier panel includes a first substrate, a second substrate and a liquid crystal layer. The first substrate includes a first opening electrode configured to operate as a first opening transmitting the light and a first barrier electrode configured to operate as a first barrier blocking the light, the first opening electrode and the first barrier electrode each having a step structure. The second substrate includes a second opening electrode configured to operate as a second opening and crossing at a right angle to the first opening electrode, and a second barrier electrode configured to operate as a second barrier and crossing at a right angle to the first barrier electrode. The liquid crystal layer is disposed between the first and second substrates.

A first voltage may be applied to the first opening electrode and a second voltage may be commonly applied to the first barrier electrode, the second opening electrode and the second barrier electrode in a portrait mode, and the first voltage may be applied to the second opening electrode and the second voltage may be commonly applied to the second barrier electrode, the first opening electrode and the first barrier electrode in a landscape mode where a position of the display panel and active barrier panel is rotated as compared to the portrait mode.

The second opening electrode and the second barrier electrode may be extended in a horizontal direction and a ratio of a width of the second opening electrode to a width of the second barrier electrode is about 1:1.

The unit-pixel may include three sub-pixels.

The unit-pixel may include four sub-pixels as a 2×2 structure.

A ratio of a width of the first opening electrode to a width of the first barrier electrode may be about 1:1.

Each of the first opening electrode and the first barrier electrode may include a 2H/1V step structure shape, wherein an area of the display panel covered by the first opening electrode and the first barrier electrode may be shifted by two sub-pixels across each column along a horizontal direction and may be shifted by one sub-pixel down each row along a vertical direction.

Each of the first opening electrode and the first barrier electrode may include a 1H/1V step structure, wherein an area of the display panel covered by the first opening electrode and the first barrier electrode may be shifted by one sub-pixel across each column along a horizontal direction and may be shifted by one sub-pixel down each row along a vertical direction.

Each of the first opening electrode and the first barrier electrode may include a 1H/2V step structure, wherein an area of the display panel covered by the first opening electrode and the first barrier electrode may be shifted by one sub-pixel across each column along a horizontal direction and may be shifted by two sub-pixels down each row along a vertical direction.

A ratio of a width of the first opening electrode to a width of the first barrier electrode may be about 1:2.

Each of the first opening electrode and the first barrier electrode may include a 2H/1V step structure, wherein an area of the display panel covered by the first opening electrode and the first barrier electrode may be shifted by two sub-pixels across each column along a horizontal direction and may be shifted by one sub-pixel down each row along a vertical direction.

Each of the first opening electrode and the first barrier electrode may include a 1H/1V step structure, wherein an area of the display panel covered by the first opening electrode and the first barrier electrode may be shifted by one sub-pixel across each column along a horizontal direction and may be shifted by one sub-pixel down each row along a vertical direction.

A ratio of a width of the first opening electrode to a width of the first barrier electrode may be about 1:3.

Each of the first opening electrode and the first barrier electrode may include a 1H/2V step structure, wherein an area of the display panel covered by the first opening electrode and the first barrier electrode may shifted by one sub-pixel across each column along a horizontal direction and may be shifted by two sub-pixels down each row along a vertical direction.

A ratio of a width of the first opening electrode to a width of the first barrier electrode may be about 1:5.

Each of the first opening electrode and the first barrier electrode may include a 1H/1V step structure, wherein an area of the display panel covered by the first opening electrode and the first barrier electrode may be shifted by one sub-pixel across each column along a horizontal direction and may be shifted by one sub-pixel down each row along a vertical direction.

Each of the first opening electrode and the first barrier electrode may include a 2H/1V step structure, wherein an area of the display panel covered by the first opening electrode and the first barrier electrode may be shifted by two sub-pixels along across each column a horizontal direction and may be shifted by one sub-pixel down each row along a vertical direction.

According to another aspect, a three-dimensional (“3D”) image display apparatus is provided. The display apparatus includes a display panel including a plurality of unit pixels, each of the unit pixels including a plurality of sub-pixels and configured to display an image in a portrait mode or a landscape mode rotated from the portrait mode, an active barrier panel including a first substrate which includes a first opening electrode and a first barrier electrode having a step structure, a second substrate which includes a second opening electrode crossing at a right angle to the first opening electrode and a second barrier electrode crossing at a right angle to the first barrier electrode, and a liquid crystal layer disposed between the first and second substrates, and a control part configured to operate the first opening electrode as a first opening transmitting light and the first barrier electrode as a first barrier blocking the light in the portrait mode, and to operate the second opening electrode as a second opening and the second barrier electrode as a second barrier in the landscape mode.

The display apparatus may further include a barrier driving part configured to drive the active barrier panel according to a control provided from the control part, wherein the barrier driving part provides the first opening electrode with a first voltage and commonly provides the first barrier electrode, the second opening electrode and the second barrier electrode with a second voltage in a portrait mode, and the barrier driving part provides the second opening electrode with the first voltage and commonly provides the second barrier electrode, the first opening electrode and the first barrier electrode with the second voltage in a landscape mode.

The unit-pixel may include three sub-pixels.

The unit-pixel may include four sub-pixels as a 2×2 structure.

A ratio of a width of the first opening electrode to a width of the first barrier electrode is asymmetric to provide an asymmetric structure, and a ratio of a width of the second opening electrode to a width of the second barrier electrode is symmetric to provide a symmetric structure, the second opening electrode and the second barrier electrode extended in a horizontal direction.

The asymmetric structure may include about 1:2, about 1:3 and about 1:5, and the symmetric structure may include about 1:1.

The display apparatus may further include a display driving part configured to display a first-eye image on n sub-pixels and to display a second-eye image on n sub-pixels (wherein, n is a natural number).

The control part may determine a condensing area at optimum view distance (“OVD”) from the active barrier panel, the condensing area including the area at the OVD at which luminance from a set of corresponding sub-pixels can be observed [?], and determine n first-eye sub-pixels and n second-eye sub-pixels based on an observer's position and the condensing area in the portrait mode, wherein the display driving part may display a first-eye image on the n first-eye sub-pixels and a second-eye image on the n second-eye sub-pixels under control of the control part.

The value of n may be three.

When the observer may be located in the OVD, the control part may determine n sub-pixels respectively corresponding to n condensing areas adjacent to an area, in which an observer' first-eye is located, as the first-eye sub-pixel and determine n sub-pixels respectively corresponding to n condensing areas adjacent to an area, in which an observer' second-eye is located, as the second-eye sub-pixel, wherein the display driving part may display the first-eye and second-eye images on the determined first-eye and second-eye sub-pixels, respectively.

When the observer may be located further away from the active barrier panel than the OVD, the control part may determine a division boundary portion on the display panel, the division boundary portion determined by an extension line connecting a center of an area in which an observer's first-eye is located with a boundary portion between the condensing areas, and determine a first-eye sub-pixel and a second-eye sub-pixel corresponding to a control area divided by the division boundary portion, wherein the display driving part may display the first-eye and second-eye images on the first-eye and second-eye sub-pixels in the control area, respectively.

The control part may control the barrier driving part to operate as a first barrier-open condition and a second barrier-open condition according to an observer's position in the landscape mode, the second barrier-open condition shifted by ½ of a width of the second opening electrode from the first barrier-open condition that is a standard condition.

The barrier driving part may selectively operate the active barrier panel as one of the first and second barrier-open conditions according to the observer's position, and the selected barrier-open condition including the second open part being nearer to a center of the condensing area adjacent to an area in which an observer's first-eye is located.

When the observer may be located in the OVD, the control part may control the display driving part to display the first-eye image on n sub-pixels corresponding to n condensing areas adjacent to an area in which an observer's first-eye is located, and to display the second-eye image on n sub-pixels adjacent to the n sub-pixels displayed the first-eye image (wherein, n is a natural number).

The value of n may be one.

When the observer may be located further away from the active barrier panel than the OVD, the control part may divide the condensing area in which an observer's first-eye is located into a central condensing area and a crosstalk area, and divide the display panel into a first area corresponding to the central condensing area and a second area corresponding to the crosstalk area by an extension line connecting a boundary portion between the central condensing area and the crosstalk area with each of areas in which observer's both eyes are located, wherein the display driving part may display the first-eye image on a sub-pixel corresponding to the condensing area in the first area, displays the second-eye image on a sub-pixel adjacent to the sub-pixel displayed the first-eye image, and displays a preset image on a sub-pixel in the second area.

The preset image may include a two-dimensional (“2D”) image, a black image or a warning image.

The active barrier panel may be used in the 3D image display apparatus which operates as the portrait mode and the landscape mode. The active barrier panel may prevent an abnormal color and a separate color, and may extend a viewing area in which the 3D image can be observed without crosstalk. In addition, the active barrier panel and the display panel may be controlled based on the observer's position, so that a display quality of the 3D image may be improved.

### BRIEF DESCRIPTION OF THE DRAWINGS

The above and other features and advantages will become more apparent by describing in detail exemplary embodiments thereof with reference to the accompanying drawings, in which:

FIG. 1 is a plan view illustrating a three-dimensional (“3D”) display module according to an exemplary embodiment;

FIG. 2 is a cross-sectional view of an active barrier panel taken along lines I-I′ and II-II′ as shown in FIG. 1;

FIGS. 3A and 3B are a method of driving the 3D display module as shown in FIG. 1 according to a pivot mode;

FIG. 4 is a plan view illustrating a 3D display module according to an exemplary embodiment of the invention;

FIG. 5 is a plan view illustrating a 3D display module according to an exemplary embodiment;

FIG. 6 is a plan view illustrating a 3D display module according to an exemplary embodiment;

FIGS. 7A and 7B are a extension views illustrating a first opening electrode as shown in FIG. 6;

FIG. 8A is a graph diagram illustrating luminance and crosstalk when a ratio of an opening to a barrier is symmetry;

FIG. 8B is a graph diagram illustrating luminance and crosstalk when a ratio of an opening to a barrier is asymmetric;

FIG. 9 is a plan view illustrating a 3D display module according to an exemplary embodiment;

FIG. 10 is a plan view illustrating a 3D display module according to an exemplary embodiment;

FIG. 11 is a plan view illustrating a 3D display module according to an exemplary embodiment;

FIGS. 12A and 12B are extended views illustrating an opening electrode as shown in FIG. 11;

FIG. 13 is a plan view illustrating a 3D display module according to an exemplary embodiment;

FIG. 14 is a plan view illustrating a landscape mode of the 3D display module as shown in FIG. 11;

FIG. 15 is a plan view illustrating a 3D display module according to an exemplary embodiment;

FIG. 16A is a graph diagram illustrating luminance and crosstalk when a ratio of an opening to a barrier is symmetric;

FIG. 16B is a graph diagram illustrating luminance and crosstalk when a ratio of an opening to a barrier is asymmetric;

FIG. 17 is a plan view illustrating a 3D display apparatus according to an exemplary embodiment;

FIG. 18 is a conceptual diagram illustrating a method of displaying a 3D image in a portrait mode according to an exemplary embodiment;

FIG. 19 is a conceptual diagram illustrating a method of displaying the 3D image according to an observer's position within an optimum view distance (“OVD”), in the portrait mode as shown in FIG. 18;

FIGS. 20A and 20B are conceptual diagrams illustrating a method of displaying the 3D image when the observer is located further away from the OVD in the portrait mode as shown in FIG. 18;

FIG. 21 is a conceptual diagram illustrating a method of displaying a 3D image in the landscape mode of the display apparatus as shown in FIG. 17;

FIG. 22 is a conceptual diagram illustrating a method of displaying the 3D image according an observer's position within the OVD, in the landscape mode as shown in FIG. 21;

FIG. 23 is a graph diagram illustrating luminance profile of a sub-pixel in the landscape mode within the OVD;

FIGS. 24A and 24B are conceptual diagrams illustrating a method of displaying the 3D image when the observer is located further away from the OVD in the landscape mode as shown in FIG. 21;

FIG. 25 is a conceptual diagram illustrating a method of displaying a 3D image in a portrait mode according to an exemplary embodiment;

FIG. 26 is a conceptual diagram illustrating a method of displaying the 3D image according to an observer's position within the OVD, in the portrait mode as shown in FIG. 25;

FIG. 27 is conceptual diagram illustrating a method of displaying the 3D image when the observer is located further away from the OVD in the portrait mode as shown in FIG. 25;

FIG. 28 is a conceptual diagram illustrating a method of displaying a 3D image in a portrait mode according to an exemplary embodiment;

FIG. 29 is a conceptual diagram illustrating a method of displaying the 3D image according to an observer's position within the OVD, in the portrait mode as shown in FIG. 28; and

FIGS. 30A and 30B are conceptual diagrams illustrating a method of displaying the 3D image when the observer is located further away from the OVD in the portrait mode as shown in FIG. 28.

### DETAILED DESCRIPTION OF THE INVENTION

Hereinafter, exemplary embodiments will be explained in detail with reference to the accompanying drawings.

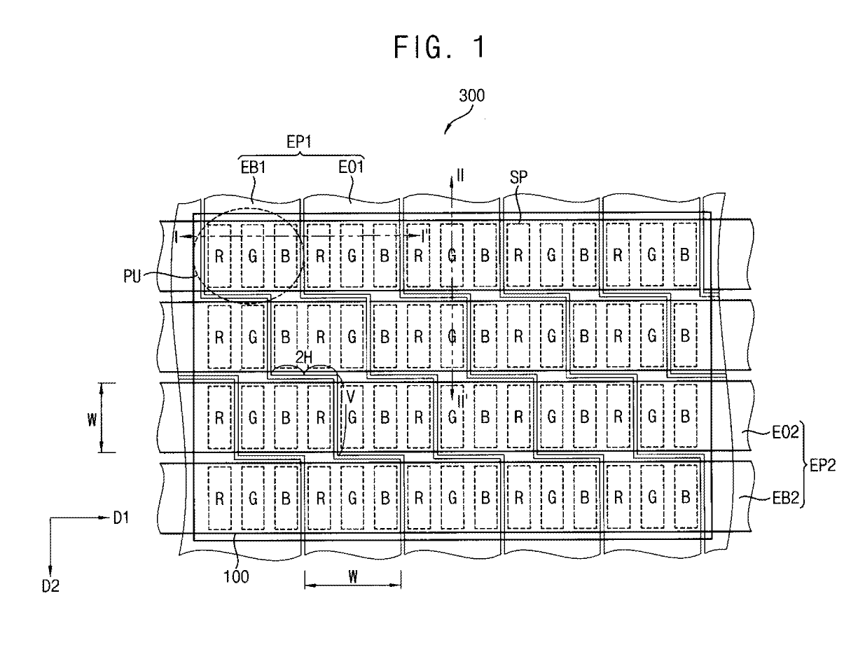

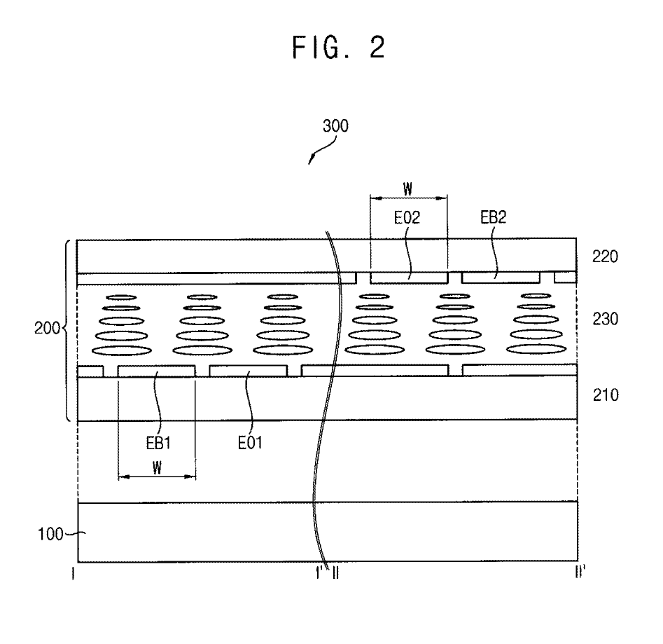

FIG. 1 is a plan view illustrating a three-dimensional (“3D”) display module according to an exemplary embodiment. FIG. 2 is a cross-sectional view of an active barrier panel taken along lines I-I′ and II-IF as shown in FIG. 1.

Referring to FIGS. 1 and 2, the 3D display module 300 includes a display panel 100 and an active barrier panel 200.

The display panel 100 may include a plurality of unit pixels PU, and each of the unit pixels PU may include sub-pixels SP of red, green and blue R, G and B. A sub-pixel SP includes a short side and a long side, and has, for example, a rectangular shape. The sub-pixels SP of red, green and blue R, G and B that have colors that are different from each other are arranged in a first direction D1 (e.g., R G B R G B . . . ), and the sub-pixels SP of the same color (R, G or B) are arranged in a second direction D2 (e.g., G G G G G . . . ). The sub-pixels SP of the red, green and blue R, G and B are arranged as a stripe structure.

The active barrier panel 200 may include a first substrate 210, a second substrate 220 and a liquid crystal layer disposed between the first and second substrates 210 and 220, and may be disposed on the display panel 100.

The first substrate 210 may include a first electrode part EP1, and the first electrode part EP1 may include a first opening electrode EO1 and a first barrier electrode EB1, each having a step structure as shown in FIG. 1, in which edges of the electrodes form a staircase shape. The first opening electrode EO1 and the first barrier electrode EB1 are adjacent to each other along their staircase-shaped edges, and fit together such that, for example, a distance between the first opening electrode EO1 and the first barrier electrode EB1 is maintained in the first electrode part EP1. Each of the first opening electrode EO1 and the first barrier electrode EB1 has a width W corresponding to three times the length of the short side of the sub-pixels SP. As shown in FIG. 1, each of the first opening electrode EO1 and the first barrier electrode EB1 are arranged with a first step structure (2H/1V, where ‘H’ indicates the width of two pixels in a horizontal direction and ‘V’ indicates the length of one pixel in the vertical direction) such that in the first step structure (2H/1V), the area covered by the electrode is shifted by two sub-pixels across each column along a short-side direction of the sub-pixel SP (horizontal direction in the portrait mode) and is shifted by one sub-pixel down each row along a long-side direction of the sub-pixel (vertical direction in the portrait mode).

The second substrate 220 may include a second electrode part EP2 and the second electrode part EP2 may include a second opening electrode EO2 and a second barrier electrode EB2. Each of the second opening electrode EO2 and the second barrier electrode EB2 has a width W corresponding to the length of the long side of a sub-pixel SP, and is extended in the first direction D1. The second opening electrode EO2 crosses at a right angle to the first opening electrode EO1 and the second barrier electrode EB2 crosses at a right angle to the first barrier electrode EB1.

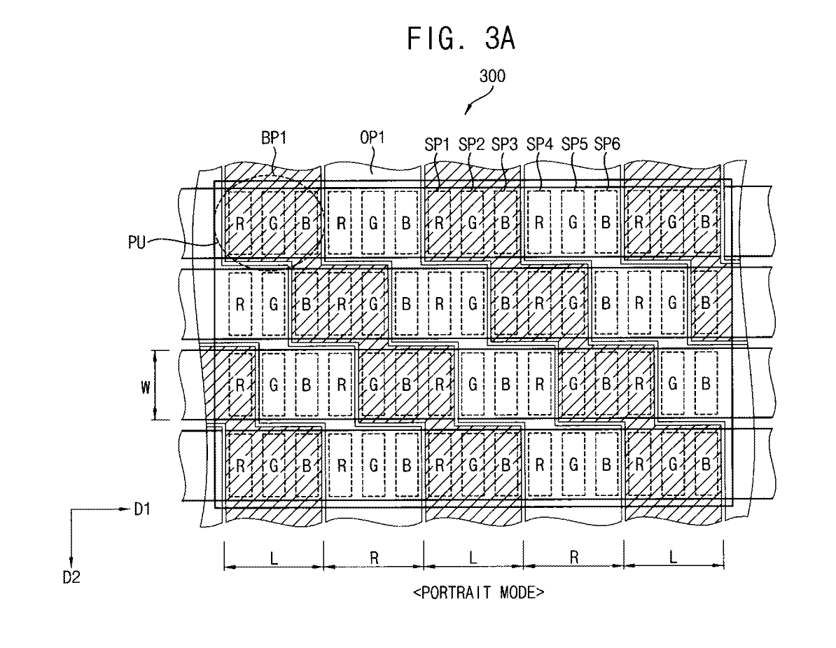

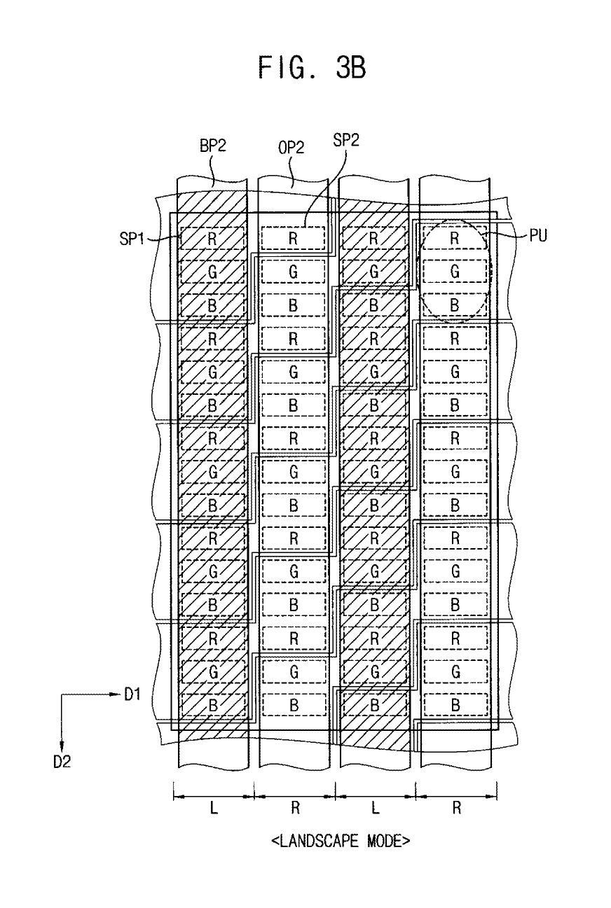

FIGS. 3A and 3B illustrate a method of driving the 3D display module as shown in FIG. 1 according to a pivot mode.

Referring to FIGS. 1 and 3A, the 3D display module 300 is used to form a display apparatus which is pivotable. The 3D display module 300 operates as a portrait mode and a landscape mode according to a pivot condition of the 3D display module 300. Hereinafter, in the portrait mode, the short side of the sub-pixel SP is parallel with the horizontal direction (first direction D1). In the landscape mode rotated about 90 degrees, for example around a center point in the display face of the display panel, with respect to the of the portrait mode, the long side of the sub-pixel SP is parallel with the horizontal direction (first direction D1).

In the portrait mode, the display panel alternately displays a left-eye image L and a right-eye image R by each unit-pixel column (i.e., each three sub-pixels SP) along the short-side direction (D1). A first voltage is applied to the first opening electrode EO1 of the active barrier panel 200, and a second voltage is applied to the first barrier electrode EB1 of the active barrier panel 200. In addition, the second voltage is applied to the second opening electrode EO2 and the second barrier electrode EB2 of the active barrier panel 200. An area of the active barrier panel 200, in which the first opening electrode EO1 is disposed, operates as a first opening OP1 transmitting light and an area of the active barrier panel 200, in which, the first barrier electrode EB1 is disposed, operates as a first barrier BP1 blocking the light. According to the present exemplary embodiment, a ratio of the area of the first opening OP1 to the area of the first barrier BP1 is about 1:1, in the portrait mode.

As shown in FIG. 3A, the first barrier BP1 has a first step structure (2H/1V) corresponding to the first barrier electrode EB1. The sub-pixels SP of the red, green and blue R, G and B disposed in an area which operates as the first opening OP1, may have a uniform distribution. Therefore, when an observer moves to the left and right sides in the portrait mode and the landscape mode, or if the display panel 100 is miss-aligned with the active barrier panel 200, an abnormal color and a separate color may be prevented.

Referring to FIGS. 1 and 3B, in the landscape mode, the display panel alternately displays a left-eye image L and a right-eye image R by each sub-pixel column along the long-side direction (D1). A first voltage is applied to the second opening electrode EO2 of the active barrier panel 200 and a second voltage is applied to the second barrier electrode EB2 of the active barrier panel 200. In addition, the second voltage is commonly applied to the first opening electrode EO1 and the first barrier electrode EB1 the active barrier panel 200. An area of the active barrier panel 200, in which the second opening electrode EO2 is disposed, operates as a second opening OP2 transmitting light, and an area of the active barrier panel 200, in which, the second barrier electrode EB2 is disposed, operates as a second barrier BP2 blocking the light. According to the present exemplary embodiment, a ratio of the area of the second barrier BP2 to the area of the second opening OP2 is about 1:1, in the landscape mode.

The second barrier BP2 includes a vertical structure corresponding to the second barrier electrode EB2. The sub-pixels SP of the red, green and blue R, G and B disposed in an area which operates as the second opening OP2, have a uniform distribution. Therefore, when an observer moves to the left and right sides, or if the display panel 100 is miss-aligned with the active barrier panel 200, an abnormal color and a separate color may be prevented.

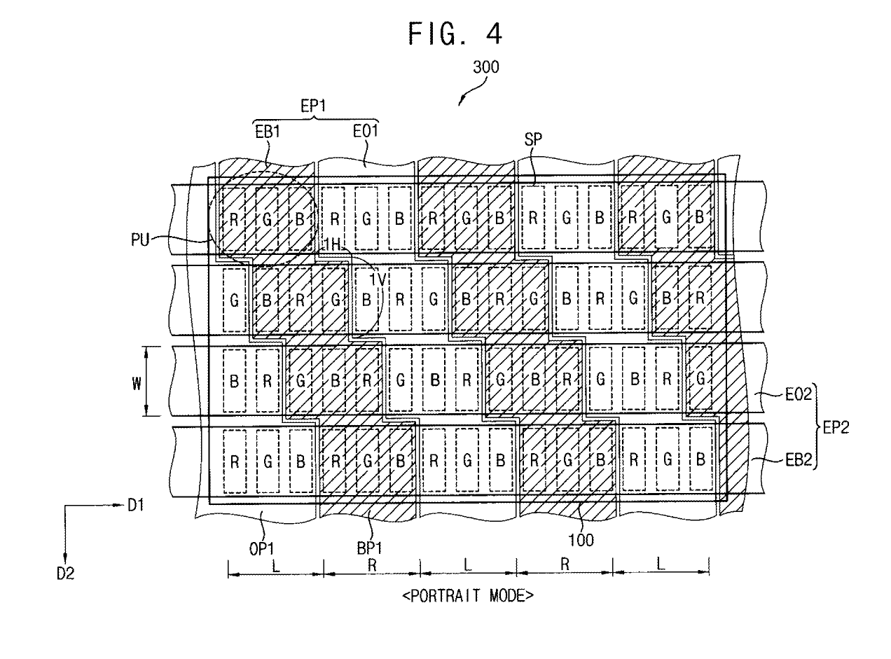

FIG. 4 is a plan view illustrating a 3D display module according to an exemplary embodiment. Hereinafter, the same reference numerals are used to refer to the same or like parts as those described in the previous exemplary embodiments, and repetitive detailed explanations are omitted or simplified.

Referring to FIGS. 2 and 4, according to the present exemplary embodiment, the 3D display module 300 may include a display panel 100 and an active barrier panel 200.

The display panel 100 may include a plurality of unit pixels PU, and each of the unit pixels PU may include sub-pixels SP of red, green and blue R, G and B. A sub-pixel SP includes a short side and a long side, and has, for example, a rectangular shape. The sub-pixels SP of red, green and blue R, G and B that have colors that are different from each other are arranged in a first direction D1 (e.g., R G B R G B . . . ) and the sub-pixel of red, green and blue R, G and B that have colors that are different from each other are arranged in a second direction D2 (e.g., R G B R G B . . . ). The sub-pixels SP of the red, green and blue R, G and B are arranged as a mosaic structure.

The active barrier panel 200 may include a first substrate 210 including a first electrode part EP1 and a second substrate 220 including a second electrode part EP2.

Each of the first opening electrode EO1 and the first barrier electrode EB1 has a width W corresponding to three times the length of the short side of the sub-pixels SP. As shown in FIG. 4, each of the first opening electrodes EO1 and the first barrier electrodes EB1 has a second step structure (1H/1V), such that the second step structure (1H/1V) is shifted by one sub-pixel across each column along a short-side direction of the sub-pixel SP and is shifted by one sub-pixel down each row along a long-side direction of the sub-pixel.

The second substrate 220 may include a second electrode part EP2 and the second electrode part EP2 may include a second opening electrode EO2 and a second barrier electrode EB2. Each of the second opening electrode EO2 and the second barrier electrode EB2 has a width W corresponding to the length of the long side of the sub-pixel SP, and is extended in the first direction D1.

According to the present exemplary embodiment, in the portrait mode, the display panel alternately displays a left-eye image L and a right-eye image R by each unit-pixel column along the short-side direction (D1). An area of the active barrier panel 200, in which the first opening electrode EO1 is disposed, operates as a first opening OP1 transmitting light and an area of the active barrier panel 200, in which, the first barrier electrode EB1 is disposed, operates as a first barrier BP1 blocking the light. Therefore, the first barrier BP1 has the second step structure 1H/1V corresponding to the first barrier electrode EB1. According to the present exemplary embodiment, a ratio of the area of the first opening OP1 to the area of the first barrier BP1 is about 1:1, in the portrait mode. According to the present exemplary embodiment, the sub-pixels SP of the red, green and blue R, G and B disposed in an area which operates as the first opening OP1, may have a uniform distribution.

The landscape mode according to the present exemplary embodiment is substantially the same as those described in FIG. 3B, and the repetitive detailed explanations are omitted.

Therefore, when an observer moves to the left and right sides in the portrait mode and the landscape mode, or if the display panel 100 is miss-aligned with the active barrier panel 200, an abnormal color and a separate color may be prevented.

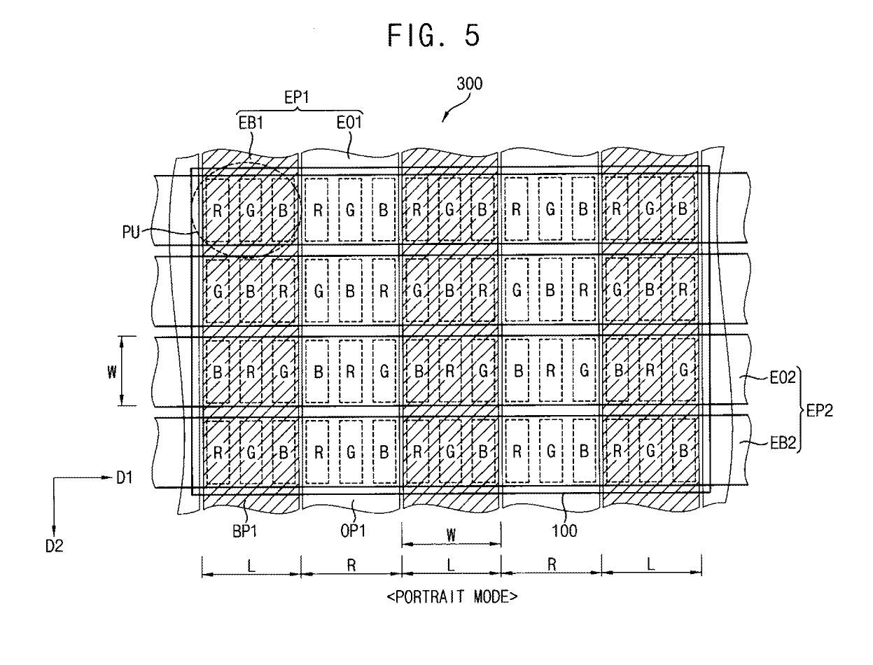

FIG. 5 is a plan view illustrating a 3D display module according to an exemplary embodiment.

Referring to FIGS. 2 and 5, according to the present exemplary embodiment, the 3D display module 300 may include a display panel 100 and an active barrier panel 200.

The display panel 100 may include a plurality of unit pixels PU, and each of the unit pixels PU may include sub-pixels SP of red, green and blue R, G and B. A sub-pixel SP includes a short side and a long side, and has, for example, a rectangular shape. The sub-pixels SP of the red, green and blue R, G and B are arranged as a mosaic structure, as shown in FIG. 5.

The active barrier panel 200 may include a first substrate 210 including a first electrode part EP1 and a second substrate 220 including a second electrode part EP2.

Each of the first opening electrode EO1 and the first barrier electrode EB1 has a width W corresponding to three times the length of the short side of the sub-pixels SP and is extended in the second direction D2.

The second substrate 220 may include a second electrode part EP2, and the second electrode part EP2 may include a second opening electrode EO2 and a second barrier electrode EB2. Each of the second opening electrode EO2 and the second barrier electrode EB2 has a width W corresponding to a length of the long side of the sub-pixels SP and is extended in the first direction D1.

According to the present exemplary embodiment, in the portrait mode, the display panel alternately displays a left-eye image L and a right-eye image R by each unit-pixel column along the short-side direction (D1). An area of the active barrier panel 200, in which the first opening electrode EO1 is disposed, operates as a first opening OP1 transmitting light, and an area of the active barrier panel 200, in which the first barrier electrode EB1 is disposed, operates as a first barrier BP1 blocking the light. Therefore, the first barrier BP1 includes the vertical structure corresponding to the first barrier electrode EB1. According to the present exemplary embodiment, a ratio of the area of the first opening OP1 to the area of the first barrier BP1 is about 1:1, in the portrait mode. According to the present exemplary embodiment, the sub-pixels SP of the red, green and blue R, G and B disposed in an area which operates as the first opening OP1, may have a uniform distribution.

The landscape mode according to the present exemplary embodiment is substantially the same as those in the previously described exemplary embodiment, and repetitive detailed explanations are omitted.

Therefore, when an observer moves to the left and right sides in the portrait mode and the landscape mode, or if the display panel 100 is miss-aligned with the active barrier panel 200, an abnormal color and a separate color may be prevented.

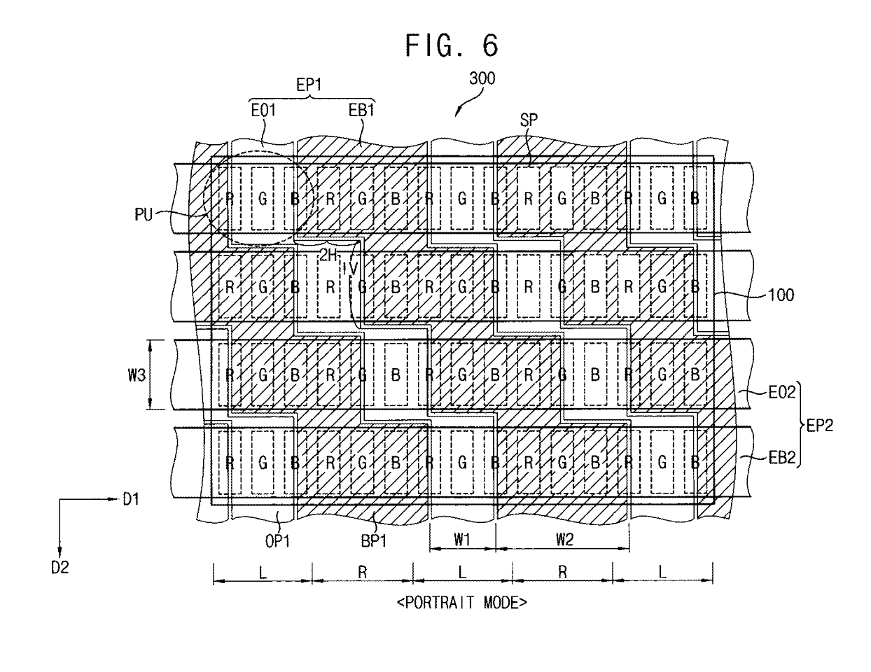

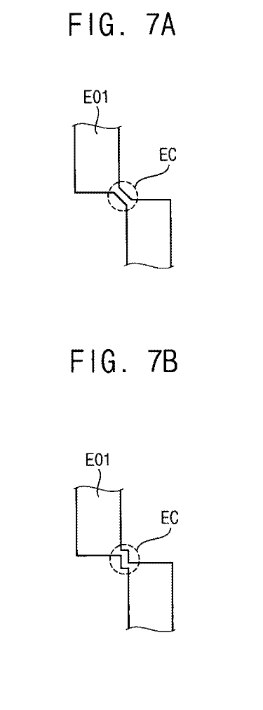

FIG. 6 is a plan view illustrating a 3D display module according to an exemplary embodiment of the invention. FIGS. 7A and 7B are enlarged views illustrating a first opening electrode as shown in FIG. 6.

Referring to FIGS. 2 and 6, the 3D display module 300 may include a display panel 100 and an active barrier panel 200.

The display panel 100 may include a plurality of unit pixels PU, and each of the unit pixels PU may include sub-pixels SP of red, green and blue R, G and B. A sub-pixel SP includes a short side and a long side, and has, for example, a rectangular shape. The sub-pixels SP of the red, green and blue R, G and B are arranged as a stripe structure.

The active barrier panel 200 may include a first substrate 210 including a first electrode part EP1 and a second substrate 220 including a second electrode part EP2.

The first electrode part EP1 corresponds to two unit pixels PU (i.e., has a width in direction D1 that is equal to the width of two pixel units PU in direction D1), and includes a first opening electrode EO1 and a first barrier electrode EB1. The first opening electrode EO1 has a first width W1, and the first barrier electrode EB1 has a second width W2 which is greater than the first width W1. A ratio of the first width W1 to the second width W2 is about 1:2. The first barrier electrode EB1 has a first step structure (2H/1V). The first step structure (2H/1V) is shifted by two sub-pixels SP along the short-side direction and is shifted by one the sub-pixel SP along the long-side direction.

Referring to FIGS. 7A and 7B, the first electrode part EP1 may include a connecting electrode EC which is connected to the first opening electrodes EO1 disposed in rows that are different from each other. The connecting electrode EC may have a diagonal shape as shown in FIG. 7A, or a step shape as shown in FIG. 7B. The shape of the connecting electrode EC is not limited thereto, and the connecting electrode EC may have various shapes.

Referring to FIG. 6, the second substrate 220 may includes a second electrode part EP2, and the second electrode part EP2 may include a second opening electrode EO2 and a second barrier electrode EB2. Each of the second opening electrode EO2 and the second barrier electrode EB2 has a third width W3 corresponding to the length of the long side of the sub-pixels SP, and is extended in the first direction D1.

According to the present exemplary embodiment, in the portrait mode, the display panel alternately displays a left-eye image L and a right-eye image R by each unit-pixel column along the short-side direction (D1). An area of the active barrier panel 200, in which the first opening electrode EO1 is disposed, operates as a first opening OP1 transmitting light, and an area of the active barrier panel 200, in which, the first barrier electrode EB1 is disposed, operates as a first barrier BP1 blocking the light. The first barrier BP1 has a first step structure (2H/1V) corresponding to the first barrier electrode EB1. According to the present exemplary embodiment, a ratio of the area of the first opening OP1 to the area of the first barrier BP1 is about 1:2, in the portrait mode.

The landscape mode according to the present exemplary embodiment is substantially the same as those in the previously described exemplary embodiment, and repetitive detailed explanations are omitted.

According to the present exemplary embodiment, the sub-pixels SP of the red, green and blue R, G and B, disposed in an area which operates as the first opening OP1, may have a uniform distribution in the portrait mode and the landscape mode. Therefore, an abnormal color and a separate color may be prevented. In addition, in the portrait mode, the ratio of the area of the first opening OP1 to the area of the first barrier BP1 is asymmetric, so that the viewing area in which the 3D image is viewed normally may be increased.

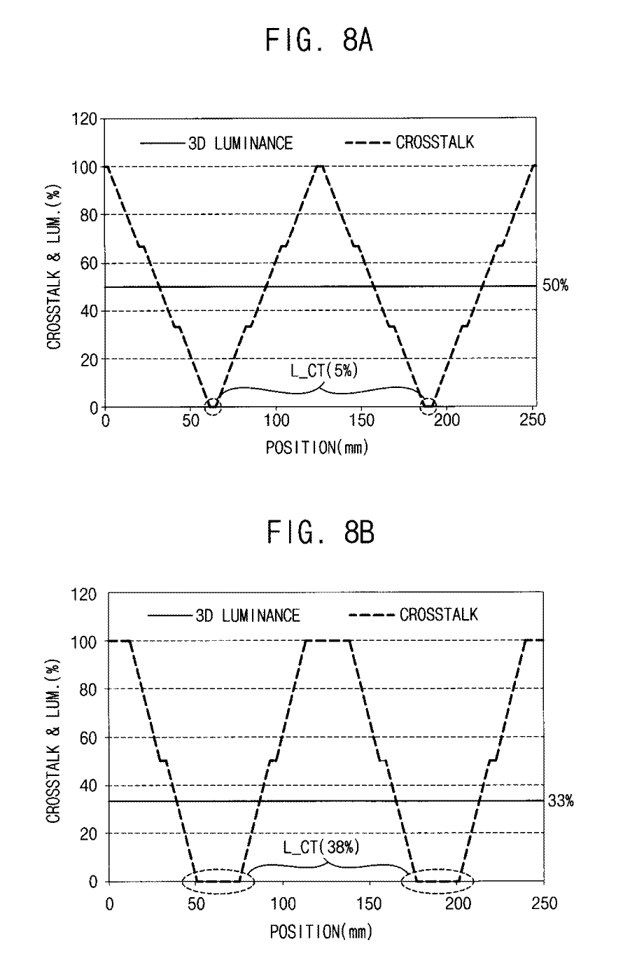

FIG. 8A is a graph diagram illustrating luminance and crosstalk when a ratio of an opening to a barrier is symmetric. FIG. 8B is a graph diagram illustrating luminance and crosstalk when a ratio of an opening to a barrier is asymmetric.

FIGS. 8A and 8B are graphs showing the 3D luminance, in a solid line, and crosstalk, in a dashed line, as a function of position across a portion of a display (in mm) according to a computer simulation result. Referring to FIG. 8A, when the ratio of the area of the opening and the area of the barrier was about 1:1, the luminance was about 50% of a normal luminance, and an area L_CT in which the crosstalk was about 0, was about 5% of an entire display area. Referring to FIG. 8B, when the ratio of the area of the opening and the area of the barrier was about 1:2, the luminance was about 33% of a normal luminance, and an area L_CT in which the crosstalk was about 0, was about 38% of an entire display area.

Therefore, when the ratio of the area of the opening and the area of the barrier is asymmetric, the luminance may be relatively decreased, but the viewing area in which the 3D image is normally viewed without the crosstalk, may be increased.

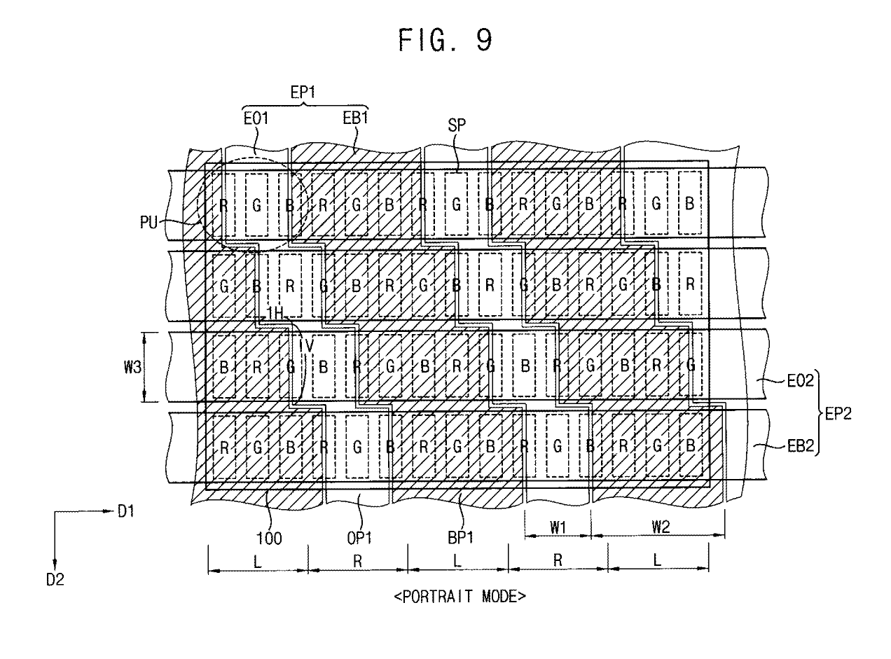

FIG. 9 is a plan view illustrating a 3D display module according to an exemplary embodiment.

Referring to FIGS. 2 and 9, according to the present exemplary embodiment, the 3D display module 300 may include a display panel 100 and an active barrier panel 200.

The display panel 100 may include a plurality of unit pixels PU, and each of the unit pixels PU may include sub-pixels SP of red, green and blue R, G and B. A sub-pixel SP includes a short side and a long side, and has, for example, a rectangular shape. The sub-pixels SP of the red, green and blue R, G and B are arranged as a mosaic structure, as shown in FIG. 9.

The active barrier panel 200 may include a first substrate 210, a second substrate 220 and a liquid crystal layer disposed between the first and second substrates 210 and 220, and may be disposed on the display panel 100.

The first electrode part EP1 corresponds to two unit pixels PU, and includes a first opening electrode EO1 and a first barrier electrode EB1. The first opening electrode EO1 has a first width W1, and the first barrier electrode EB1 has a second width W2 that is greater than the first width W1. A ratio of the first width W1 to the second width W2 is about 1:2. The first barrier electrode EB1 has a second step structure (1H/1V). The second step structure (1H/1V) is shifted by one sub-pixel SP along the short-side direction and is shifted by one the sub-pixel SP along the long-side direction.

The second substrate 220 may include a second electrode part EP2, and the second electrode part EP2 may include a second opening electrode EO2 and a second barrier electrode EB2. Each of the second opening electrode EO2 and the second barrier electrode EB2 has a third width W3 corresponding to the length of the long side of the sub-pixel SP, and is extended in the first direction D1

According to the present exemplary embodiment, in the portrait mode, the display panel alternately displays a left-eye image L and a right-eye image R by each unit-pixel column along the short-side direction (D1). An area of the active barrier panel 200, in which the first opening electrode EO1 is disposed, operates as a first opening OP1 transmitting light, and an area of the active barrier panel 200, in which the first barrier electrode EB1 is disposed, operates as a first barrier BP1 blocking the light. Therefore, the first barrier BP1 has the second step structure 1H/1V corresponding to the first barrier electrode EB1. According to the present exemplary embodiment, a ratio of the area of the first opening OP1 to the area of the first barrier BP1 is about 1:2, in the portrait mode.

The landscape mode according to the present exemplary embodiment is substantially the same as those in the previously described exemplary embodiment, and repetitive detailed explanations are omitted.

According to the present exemplary embodiment, in the portrait mode and the landscape mode, the sub-pixels SP of the red, green and blue R, G and B disposed in an area which operates as the first opening OP1, may have a uniform distribution. Therefore, an abnormal color and a separate color may be prevented. In addition, in the portrait mode, the ratio of the area of the first opening OP1 to the area of the first barrier BP1 is asymmetric so that the viewing area in which the 3D image is viewed normally may be increased.

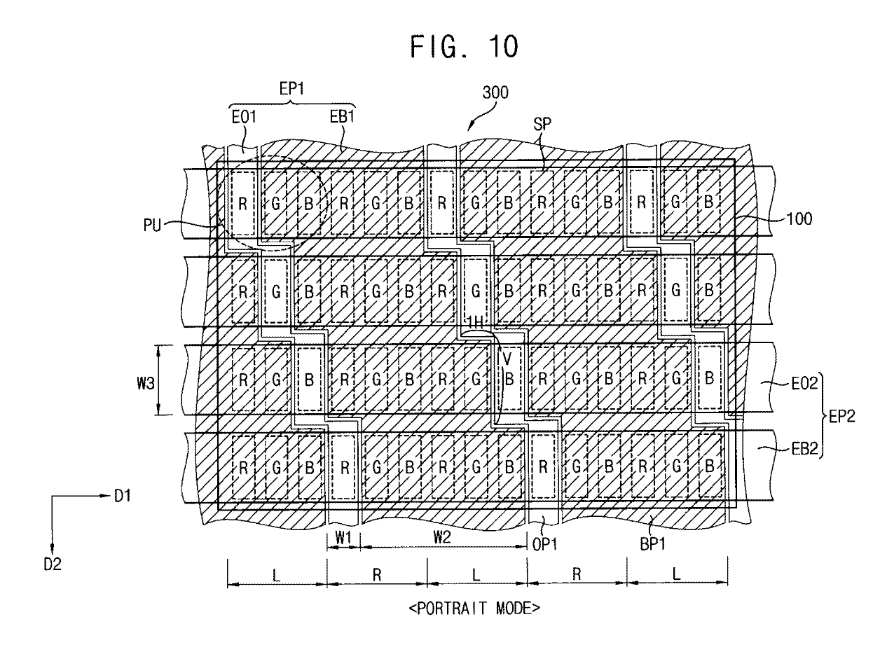

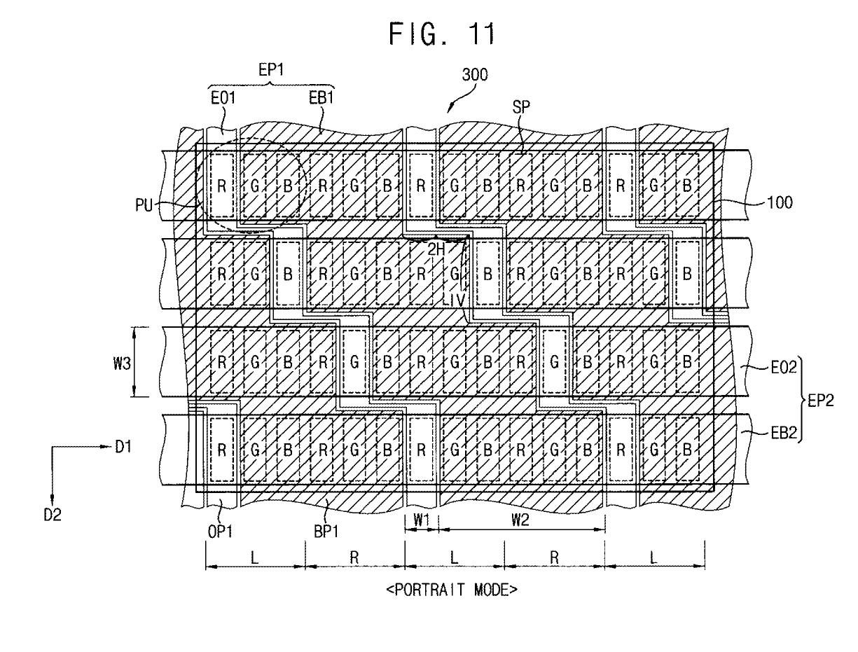

FIG. 10 is a plan view illustrating a 3D display module according to an exemplary embodiment.

Referring to FIGS. 2 and 10, the 3D display module 300 may include a display panel 100 and an active barrier panel 200.

The display panel 100 may include a plurality of unit pixels PU, and each of the unit pixels PU may include sub-pixels SP of red, green and blue R, G and B. A sub-pixel SP includes a short side and a long side, and has, for example, a rectangular shape. The sub-pixels SP of the red, green and blue R, G and B are arranged as a stripe structure.

The active barrier panel 200 may include a first substrate 210 including a first electrode part EP1 and a second substrate 220 including a second electrode part EP2.

The first electrode part EP1 corresponds to two unit pixels PU, and includes a first opening electrode EO1 and a first barrier electrode EB1. The first opening electrode EO1 has a first width W1, and the first barrier electrode EB1 has a second width W2 that is greater than the first width W1. A ratio of the first width W1 to the second width W2 is about 1:5. The first barrier electrode EB1 has a second step structure (1H/1V). The second step structure (1H/1V) is shifted by one sub-pixels SP along the short-side direction and is shifted by one the sub-pixel SP along the long-side direction.

The second substrate 220 may include a second electrode part EP2 and the second electrode part EP2 may include a second opening electrode EO2 and a second barrier electrode EB2. Each of the second opening electrode EO2 and the second barrier electrode EB2 has a third width W3 corresponding to the length of the long side of the sub-pixel SP, and is extended in the first direction D1.

According to the present exemplary embodiment, in the portrait mode, the display panel alternately displays a left-eye image L and a right-eye image R by each unit-pixel column along the short-side direction (D1). An area of the active barrier panel 200, in which the first opening electrode EO1 is disposed, operates as a first opening OP1 transmitting light and an area of the active barrier panel 200, in which, the first barrier electrode EB1 is disposed, operates as a first barrier BP1 blocking the light. The first barrier BP1 has a second step structure (1H/1V) corresponding to the first barrier electrode EB1. According to the present exemplary embodiment, a ratio of the area of the first opening OP1 to the area of the first barrier BP1 is about 1:5, in the portrait mode.

The landscape mode according to the present exemplary embodiment is substantially the same as those described in the previous exemplary embodiment, and repetitive detailed explanations are omitted.

According to the present exemplary embodiment, in the portrait mode and the landscape mode, the sub-pixels SP of the red, green and blue R, G and B disposed in an area which operates as the first opening OP1, may have a uniform distribution. Therefore, an abnormal color and a separate color may be prevented. In addition, in the portrait mode, the ratio of the area of the first opening OP1 to the area of the first barrier BP1 is asymmetric, so that the viewing area in which the 3D image is viewed normally may be increased.

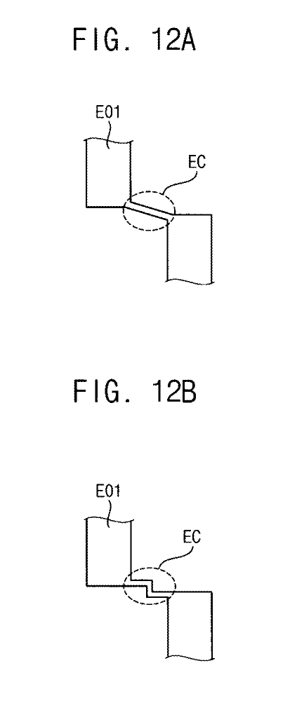

FIG. 11 is a plan view illustrating a 3D display module according to an exemplary embodiment of the invention. FIGS. 12A and 12B are extended views illustrating an opening electrode as shown in FIG. 11.

Referring to FIGS. 2 and 11, the 3D display module 300 may include a display panel 100 and an active barrier panel 200.

The display panel 100 may include a plurality of unit pixels PU, and each of the unit pixels PU may include sub-pixels SP of red, green and blue R, G and B. A sub-pixel SP includes a short side and a long side that has, for example, a rectangular shape. The sub-pixels SP of the red, green and blue R, G and B are arranged as a stripe structure.

The active barrier panel 200 may include a first substrate 210 including a first electrode part EP1, and a second substrate 220 including a second electrode part EP2.

The first electrode part EP1 corresponds to two unit pixels PU, and includes a first opening electrode EO1 and a first barrier electrode EB1. The first opening electrode EO1 has a first width W1, and the first barrier electrode EB1 has a second width W2 that is greater than the first width W1. A ratio of the first width W1 to the second width W2 is about 1:5. The first barrier electrode EB1 has a first step structure (2H/1V). The first step structure (2H/1V) is shifted by one sub-pixels SP along the short-side direction and is shifted by one the sub-pixel SP along the long-side direction.

Referring to FIGS. 12A and 12B, the first electrode part EP1 may include a connecting electrode EC, which is connected to the first opening electrodes EO1 disposed in rows different from each other. The connecting electrode EC may have a diagonal shape as shown in FIG. 12A, or a step shape as shown in FIG. 12B. The connecting electrode EC is not limited thereto, and may have various shapes.

Referring to FIG. 11, the second substrate 220 may includes a second electrode part EP2, and the second electrode part EP2 may include a second opening electrode EO2 and a second barrier electrode EB2. Each of the second opening electrode EO2 and the second barrier electrode EB2 has a third width W3 corresponding to the length of the long side of the sub-pixel SP, and is extended in the first direction D1.

According to the present exemplary embodiment, in the portrait mode, the display panel alternately displays a left-eye image L and a right-eye image R by each unit-pixel column along the short-side direction (D1). An area of the active barrier panel 200, in which the first opening electrode EO1 is disposed, operates as a first opening OP1 transmitting light, and an area of the active barrier panel 200, in which the first barrier electrode EB1 is disposed, operates as a first barrier BP1 blocking the light. The first barrier BP1 has a first step structure (2H/1V) corresponding to the first barrier electrode EB1. According to the present exemplary embodiment, a ratio of the area of the first opening OP1 to the area of the first barrier BP1 is about 1:5, in the portrait mode.

The landscape mode according to the present exemplary embodiment is substantially the same as those described in the previous exemplary embodiment, and repetitive detailed explanations are omitted.

According to the present exemplary embodiment, in the portrait mode and the landscape mode, the sub-pixels SP of the red, green and blue R, G and B disposed in an area which operates as the first opening OP1, may have a uniform distribution. Therefore, an abnormal color and a separate color may be prevented. In addition, in the portrait mode, the ratio of the area of the first opening OP1 to the area of the first barrier BP1 is asymmetry structure so that a viewing area in which the 3D image is viewed normally, may be increased.

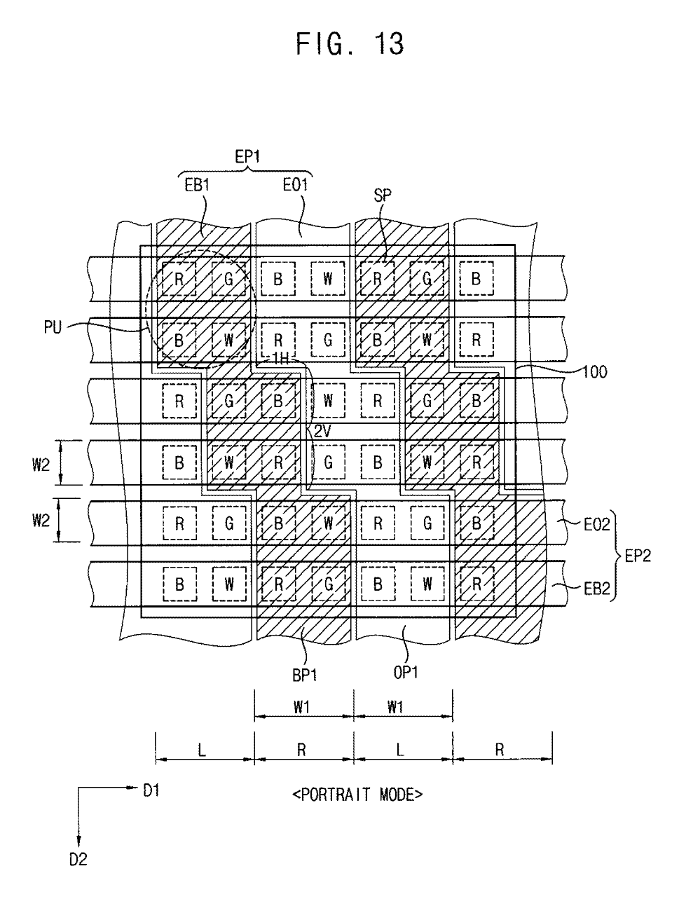

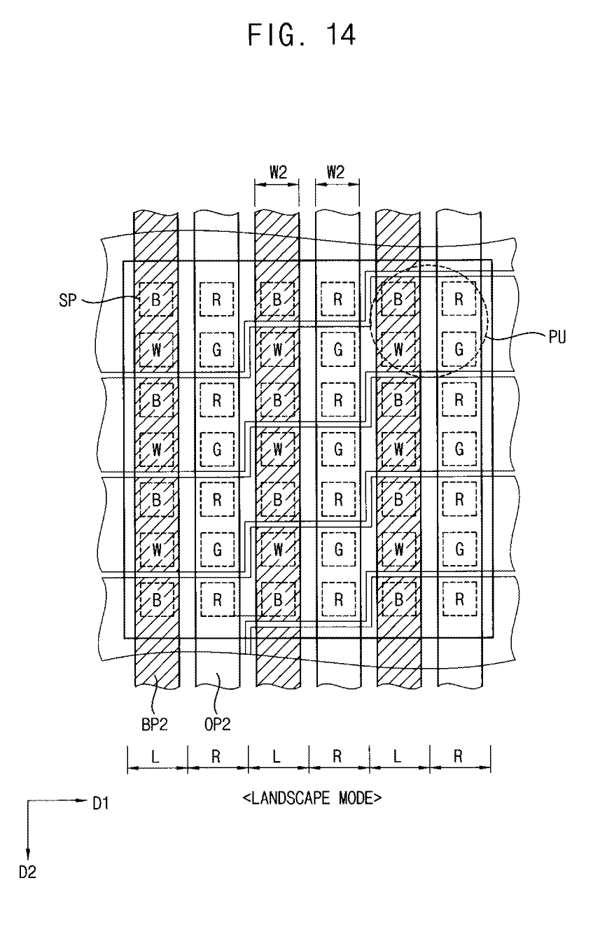

FIG. 13 is a plan view illustrating a 3D display module according to an exemplary embodiment. FIG. 14 is a plan view illustrating a landscape mode of the 3D display module as shown in FIG. 11.

Referring to FIGS. 2 and 13, the 3D display module 300 may include a display panel 100 and an active barrier panel 200.

The display panel 100 may include a plurality of unit pixels PU, and each of the unit pixels PU may include sub-pixel SP of red, green, blue and white R, G, B and W. The sub-pixels SP of the red, green, blue and white R, G, B and W are arranged as a 2×2 structure, that is, the pixel unit PU includes 2 sub-pixels SP along direction D1 and 2 sub-pixels SP along direction D2. A sub-pixel SP may have, for example, a square shape. The sub-pixels SP are repetitively disposed by every four colors along a first direction D1 (e.g., R G B W R G B W . . . ) and disposed by every two colors along a second direction D2 crossing the first direction D1 (e.g., R B R B R B R B . . . ).

The active barrier panel 200 may include a first substrate 210 including a first electrode part EP1, and a second substrate 220 including a second electrode part EP2. The first electrode part EP1 may include a first opening electrode EO1 and a first barrier electrode EB1. Each of the first opening electrode EO1 and the first barrier electrode EB1 has a first width W1 corresponding to a unit-pixel PU and has a third step structure (1H/2V). The third step structure (1H/2V) is shifted by one sub-pixel across each column along the first direction D1 (horizontal direction in the portrait mode) and is shifted by two sub-pixels down each row along the second direction D2 (vertical direction in the portrait mode).

The second electrode part EP2 may include a second opening electrode EO2 and a second barrier electrode EB2. Each of the second opening electrode EO2 and the second barrier electrode EB2 has a second width W2 corresponding to the sub-pixel SP and extended in the first direction D1.

According to the present exemplary embodiment, referring to FIG. 13, in the portrait mode, four sub-pixels of the red, green, blue and white R, G, B and W are repetitively arranged along the horizontal direction (first direction D1), and sub-pixels corresponding to two colors of the red, green, blue and white R, G, B and W are repetitively arranged along the vertical direction (second direction D2).

According to the present exemplary embodiment, referring to FIG. 14, in the landscape mode, the sub-pixels corresponding to two colors of the red, green, blue and white R, G, B and W are repetitively arranged along the horizontal direction (first direction D1) and four sub-pixels of the red, green, blue and white R, G, B and W are repetitively arranged along the vertical direction (second direction D2).

In the portrait mode, the display panel alternately displays a left-eye image L and a right-eye image R by each unit-pixel column along the first direction (D1). An area of the active barrier panel 200, in which the first opening electrode EO1 is disposed, operates as a first opening OP1 transmitting light, and an area of the active barrier panel 200, in which the first barrier electrode EB1 is disposed, operates as a first barrier BP1 blocking the light. Therefore, the first barrier BP1 has the third step structure (1H/2V) corresponding to the first barrier electrode EB1. According to the present exemplary embodiment, a ratio of the area of the first opening OP1 to the area of the first barrier BP1 is about 1:1, in the portrait mode.

Referring to FIG. 14, according to the present exemplary embodiment, in the landscape mode, the display panel alternately displays a left-eye image L and a right-eye image R by each sub-pixel column along the first direction (D1). An area of the active barrier panel 200, in which the second opening electrode EO2 is disposed, operates as a second opening OP2 transmitting light, and an area of the active barrier panel 200, in which the second barrier electrode EB2 is disposed, operates as a second barrier BP2 blocking the light. According to the present exemplary embodiment, a ratio of the area of the second barrier BP2 to the area of the second opening OP2 is about 1:1, in the landscape mode.

According to the present exemplary embodiment, the sub-pixels SP of the red, green, blue and white R, G, B and W disposed in an area which operates as the first opening OP1, may have a uniform distribution in the portrait mode and the landscape mode. Therefore, an abnormal color and a separate color may be prevented.

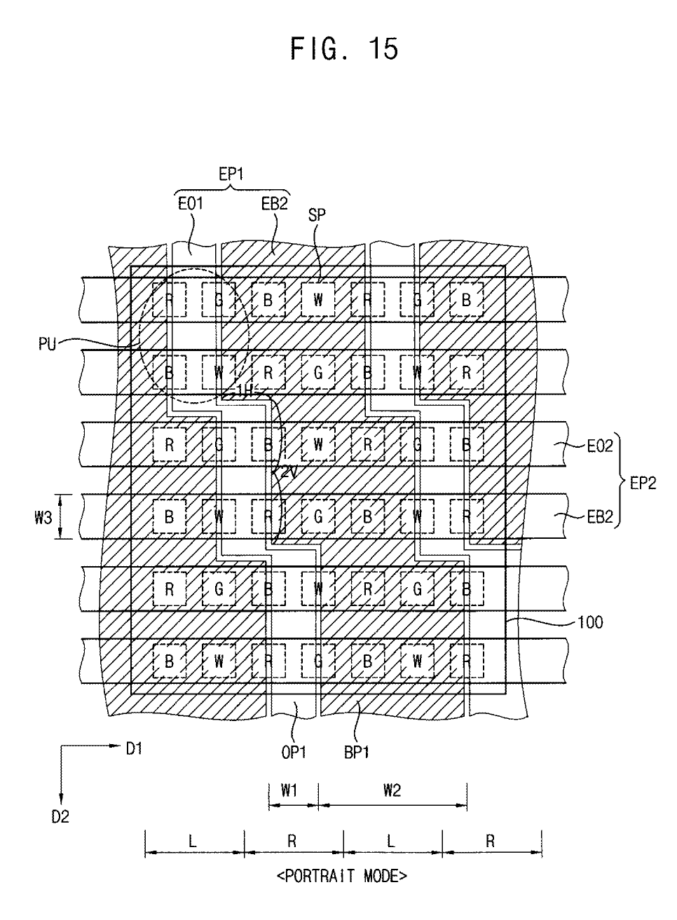

FIG. 15 is a plan view illustrating a 3D display module according to an exemplary embodiment of the invention.

Referring to FIGS. 2 and 15, the 3D display module 300 may have a display panel 100 and an active barrier panel 200.

The display panel 100 may include a plurality of unit pixels PU, and each of the unit pixels PU may include sub-pixel SP of red, green, blue and white R, G, B and W. The sub-pixels SP of the red, green, blue and white R, G, B and W are arranged as 2×2 structure in the unit pixel PU.

The active barrier panel 200 may include a first substrate 210 including a first electrode part EP1, and a second substrate 220 including a second electrode part EP2. The first electrode part EP1 may include a first opening electrode EO1 and a first barrier electrode EB1. The first opening electrode EO1 has a first width W1, and the first barrier electrode EB1 has a second width W2 that is greater than the first width W1. A ratio of the width of the first opening electrode EO1 to the width of the first barrier electrode EB1 is about 1:3. Each of the first opening electrode EO1 and the first barrier electrode EB1 has a third step structure (1H/2V). The third step structure (1H/2V) is shifted by one sub-pixel along the first direction D1 and is shifted by two sub-pixels along the second direction D2.

The second electrode part EP2 may include a second opening electrode EO2 and a second barrier electrode EB2. Each of the second opening electrode EO2 and the second barrier electrode EB2 has a third width W3 corresponding to the sub-pixel SP and extended in the first direction D1.

According to the present exemplary embodiment, in the portrait mode, the display panel alternately displays a left-eye image L and a right-eye image R by each unit-pixel column along the first direction (D1). An area of the active barrier panel 200, in which the first opening electrode EO1 is disposed, operates as a first opening OP1 transmitting light, and an area of the active barrier panel 200, in which, the first barrier electrode EB1 is disposed, operates as a first barrier BP1 blocking the light. Therefore, the first barrier BP1 has the third step structure (1H/2V) corresponding to the first barrier electrode EB1.

According to the present exemplary embodiment, a ratio of the area of the first opening OP1 to the area of the first barrier BP1 is about 1:3, in the portrait mode.

According to the present exemplary embodiment, in the portrait mode, an area of the active barrier panel 200, in which the first opening electrode EO1 is disposed, operates as a first opening OP1 transmitting light, and an area of the active barrier panel 200, in which the first barrier electrode EB1 is disposed, operates as a first barrier BP1 blocking the light. Therefore, the first barrier BP1 has the third step structure (1H/2V) corresponding to the first barrier electrode EB1.

The landscape mode according to the present exemplary embodiment is substantially the same as those described in the previous exemplary embodiment, and repetitive detailed explanations are omitted.

According to the present exemplary embodiment, in the portrait mode and the landscape mode, the sub-pixels SP of the red, green, white and blue R, G, B and W disposed in an area which operates as the first opening OP1, may have a uniform distribution. Therefore, an abnormal color and a separate color may be prevented.

In addition, in the portrait mode, the ratio of the area of the first opening OP1 to the area of the first barrier BP1 is asymmetric, so that a viewing area in which the 3D image is viewed normally, may be increased.

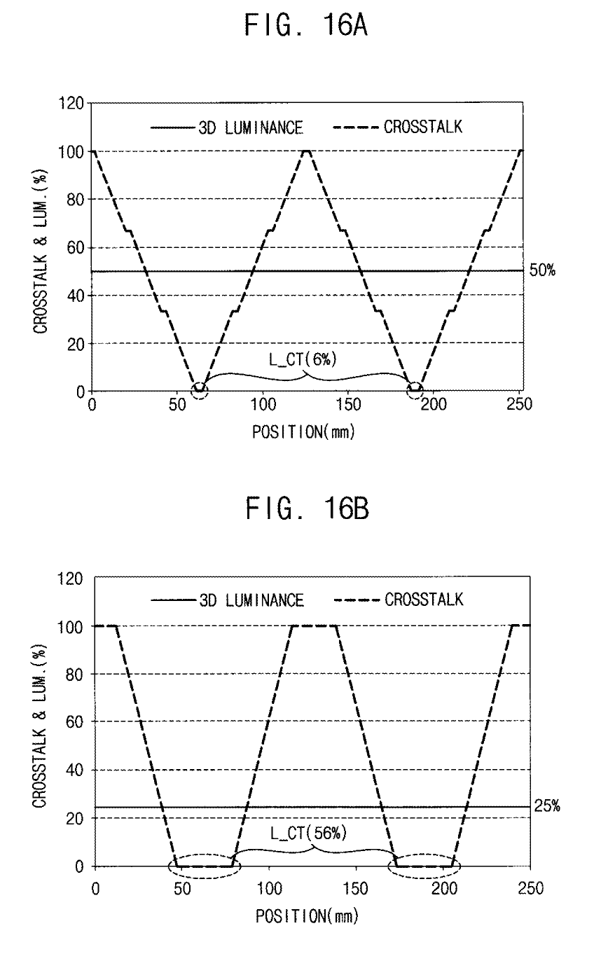

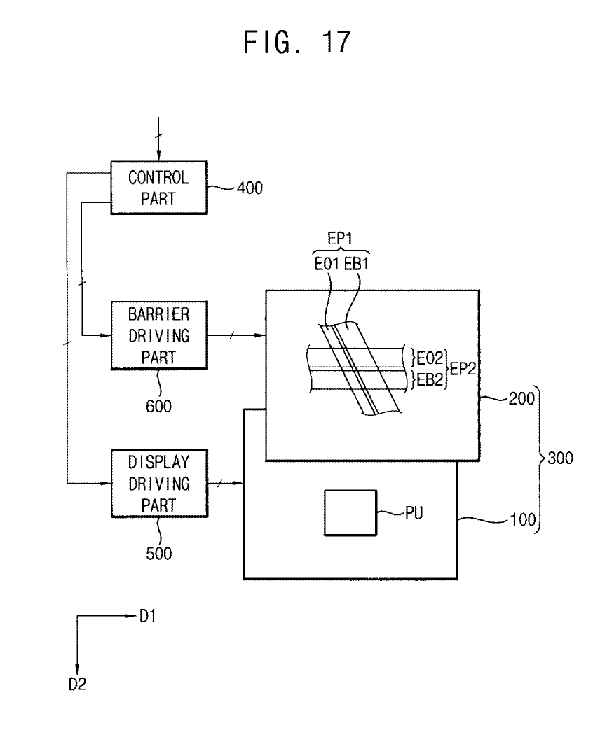

FIGS. 16A and 16B are graphs showing the 3D luminance, in a solid line, and crosstalk, in a dashed line, as a function of position across a portion of a display (in mm) according to a computer simulation result. FIG. 16A is a graph diagram illustrating luminance and crosstalk when a ratio of an opening to a barrier is symmetric. FIG. 16B is a graph diagram illustrating luminance and crosstalk when a ratio of an opening to a barrier is asymmetric.

Referring to FIG. 16A, when the ratio of the area of the opening and the area of the barrier was about 1:1, the luminance was about 50% of a normal luminance, and an area L_CT in which the crosstalk was about 0, was about 6% of an entire display area. Referring to FIG. 16B, when the ratio of the area of the opening and the area of the barrier was about 1:3, the luminance was about 25% of a normal luminance and an area L_CT in which the crosstalk was about 0, was about 56% of an entire display area.

Therefore, when the ratio of the area of the opening and the area of the barrier is an asymmetric, the luminance may be relatively decreased, but a viewing area in which the 3D image is normally viewed without the crosstalk, may be increased.

FIG. 17 is a plan view illustrating a 3D display apparatus according to an exemplary embodiment.

Referring to FIG. 17, the 3D image display apparatus may include a 3D display module 300, a control part 400, a display driving part 500 and a barrier driving part 600.

The 3D display module 300 may include a display panel 100 and an active barrier panel 200. The 3D display module 300 may be driven with a portrait mode and a landscape mode according to a pivot condition of the 3D display module 300.

The display panel 100 may include a plurality of unit pixels PU, and may display a left-eye image L and a right-eye image R. The unit-pixel PU may include sub-pixels SP of red, green and blue R, G and B. Thus, display panel 100 may include sub-pixels SP and the sub-pixels SP may be arranged as a stripe structure or a mosaic structure, as described above. Alternatively, the unit-pixel PU may include sub-pixels SP of red, green, blue and white R, G, B and W.

The active barrier panel 200 may include a first electrode part EP1 and a second electrode part EP2. The first electrode part EP1 may include a first opening electrode EO1 and a first barrier electrode EB1. The second electrode part EP2 may include a second opening electrode EO2 and a second barrier electrode EB2.

A ratio of the width of the first opening electrode EO1 to the width of the first barrier electrode EB1 may be asymmetric and a ratio of the width of the second opening electrode EO2 to the width of the second barrier electrode EB2 may be symmetric.

In the portrait mode, the first opening electrode EO1 of the first electrode part EP1 operates as a first opening, and the first barrier electrode EB1 of the first electrode part EP1 operates as a first barrier. In addition, in the landscape mode, the second opening electrode EO2 of the second electrode part EP2 operates as a second opening and the second barrier electrode EB2 of the second electrode part EP2 operates as a second barrier.

The control part 400 controls the operation of the display driving part 500 and the barrier driving part 600 based on the display mode—portrait or landscape—of the display. In addition, the control part 400 controls the display driving part 500 and the barrier driving part 600 based on an observer's position.

For example, the control part 400 controls the 3D image that is displayed on the display panel 100 and the barrier-open condition of the active barrier panel 200 based on one of the following cases of the location of the observer and mode of the display: (i) when the observer is located within an optimum view distance (“OVD”) in the portrait mode; (ii) when the observer is located further away from the OVD in the portrait mode; (iii) when the observer is located within the OVD in the landscape mode; (iv) when the observer is located further away from the OVD in the landscape mode.

The display driving part 500 displays the left-eye image and the right-eye image on the display panel 100 under the control of the control part 400.

The barrier driving part 600 controls the barrier-open condition of the active barrier panel 200 under the control of the control part 400.

Hereinafter, a method of displaying the 3D image is explained, based on a sub-pixel structure of the display panel, a area ratio of the opening to the barrier, an observer's position and so on, and the same reference numerals are used to refer to the same or like parts as those described in the previous exemplary embodiments.

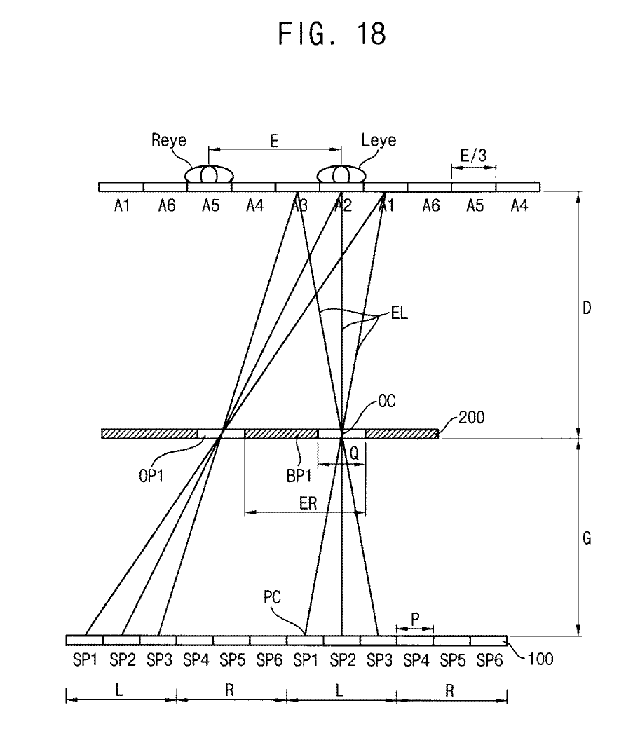

FIG. 18 is a conceptual diagram illustrating a method of displaying a 3D image in a portrait mode according to an exemplary embodiment.

Referring to FIGS. 17 and 18, according to the present exemplary embodiment, the method of displaying the 3D image in the portrait mode using the 3D display module as shown in FIG. 6 is explained.

In the portrait mode, the unit-pixel PU of the display panel 100 may include the sub-pixels SP of red, green and blue. A first unit-pixel of the display panel 100 displays a left-eye image and a second unit-pixel of the display panel 100 displays a right-eye image. That is, first, second and third sub-pixels SP1, SP2 and SP3 of the first unit-pixel display the left-eye image L, and fourth, fifth and sixth sub-pixels SP4, SP5 and SP6 display the right-eye image R.

The active barrier panel 200 may include a first electrode part EP1 of a first step structure (2H/1V) and may operate as a first opening OP1 and a first barrier BP1. A ratio of the area of the first opening OP1 to the area of the first barrier BP1 may be about 1:2.

In the present exemplary embodiment, when a distance between an observer's two eyes is E, a width of the unit-pixel PU is P, a width of the first electrode part EP1 is ER, a width of the first opening OP1 is Q, a gap between the active barrier panel 200 and the display panel 100 is G, and the distance of the observer from the active barrier panel 200 at the OVD is D, the following Equation 1 may be satisfied.

$$\frac{P}{3} ∷ G = \frac{E}{3} : D \\ D : Q = ( D + G ) : \frac{2 P}{3} \\ D = \frac{GE}{P} \\ Q = \frac{2 PD}{3 ( D + G )} \\ ER = 3 Q \qquad \text{<Equation 1>}$$

The control part 400 determines a condensing area for the case in which D is the OVD and the light radiated from a corresponding sub-pixel is condensed into the condensing area. The condensing area is an area which is spaced apart from the active barrier panel 200 and is on a plane parallel to the surface of the active barrier panel. A central area of the condensing area is determined as an area at the OVD D, in which an extension line EL connecting a central portion PC of the sub-pixel SP with a central portion OC of the first opening OP1 arrives at the OVD D. The length of the condensing area is determined as E/3 in a horizontal direction.

Therefore, first, second, third, fourth, fifth and sixth condensing areas A1, A2, A3, A4, A5 and A6 may be determined at the OVD D corresponding to first, second, third, fourth, fifth and sixth sub-pixels SP1, SP2, SP3, SP4, SP5 and SP6.

The control part 400 controls the display driving part 500 to display the left-eye image L and the right-eye image R on the first, second, third, fourth, fifth and sixth sub-pixels SP1, SP2, SP3, SP4, SP5 and SP6, based on the observer's position.

As shown in FIG. 18, when the observer's right-eye Reye is located in the fifth condensing area A5, the display driving part 500 displays the right-eye image R on the fourth, fifth and sixth sub-pixels SP4, SP5 and SP6 respectively corresponding to the fifth condensing area A5 and the sixth and fourth condensing areas A6 and A4 which are adjacent to the fifth condensing area A5. The display driving part 500 displays the left-eye image L on the first, second and third sub-pixels SP1, SP2 and SP3 respectively corresponding to the remainder first, second and third condensing areas A1, A2 and A3.

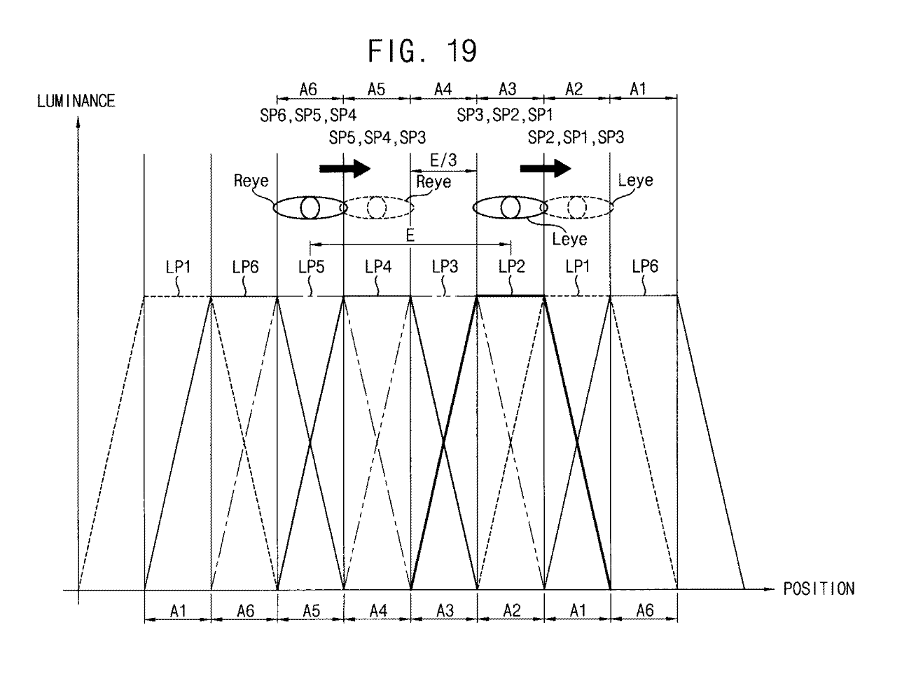

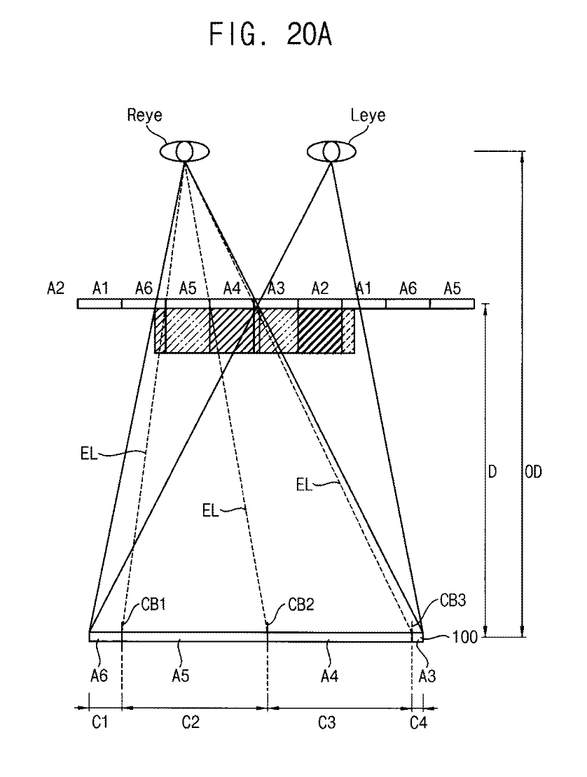

FIG. 19 is a conceptual diagram illustrating a method of displaying the 3D image according to an observer's position within the OVD, in the portrait mode as shown in FIG. 18.

Referring to FIGS. 18 and 19, the first, second, third, fourth, fifth and sixth sub-pixels SP1, SP2, SP3, SP4, SP5 and SP6 may have first, second, third, fourth, fifth and sixth luminance profiles LP1, LP2, LP3, LP4, LP5 and LP6 at the OVD D.

When the observer's right-eye Reye is located in the fifth condensing area A5, the observer's right-eye Reye may observe the right-eye image R displayed on the fourth, fifth and sixth sub-pixels SP4, SP5 and SP6 and the observer's left-eye Leye may observe the left-eye image L on the first, second and third sub-pixels SP1, SP2 and SP3.

However, when the observer moves by a distance of E/3 in a rightward direction, as indicated by the bold arrow in FIG. 19, the control part 400 analyzes a position of the observer's right-eye Reye which, in its new position, is located in the fourth condensing area A4, as indicated by the Reye in the dashed lines. The control part 400 controls the display driving part 500, so that the display driving part 500 displays the right-eye image R corresponding to the right-eye Reye on the third, fourth and fifth sub-pixels SP3, SP4 and SP5 corresponding to the fourth condensing area A4 and the fifth and third condensing areas A5 and A3 which are adjacent to the fourth condensing area A4. Then the display driving part 500 displays the left-eye image L corresponding to the left-eye Leye on the first, second and sixth sub-pixels SP1, SP2 and SP6 corresponding to the remainder first, second and sixth condensing areas A1, A2 and A6 except for the third, fourth and fifth condensing areas A3, A4 and A5.

As described above, according to the present exemplary embodiment, when the observer moves, staying within the OVD D, the 3D image display apparatus controls the left-eye and right-eye images L and R displayed on the sub-pixels SP based on the observer's position so that the 3D image may be displayed without a crosstalk.

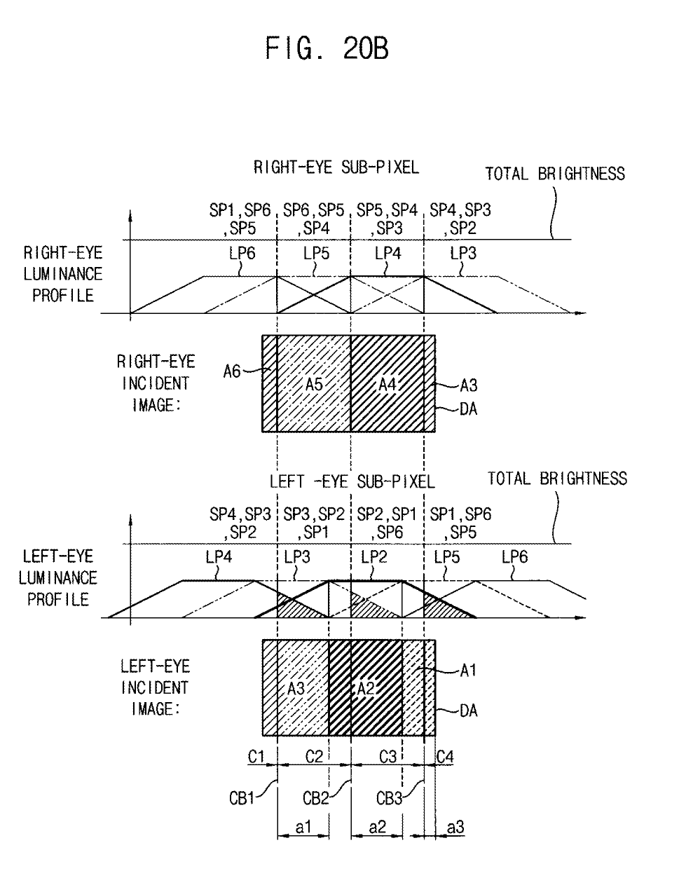

FIGS. 20A and 20B are conceptual diagrams illustrating a method of displaying the 3D image when the observer is located further away from the active barrier panel 200, and is outside of the OVD in the portrait mode as shown in FIG. 18.

Referring to FIGS. 17, 18 and 20A, the control part 400 analyzes the observer's position OD and determines if the observer's position OD is located further away from the active barrier panel 200 than the OVD D.

The control part 400 determines a position of one eye of the observer's eyes. For example, the control part 400 determines a position of the observer's right-eye Reye. The control part 400 analyzes the position of the observer's right-eye Reye and the condensing areas distributed at the OVD D. According to the analyzed result, the observer's right-eye Reye observes the light condensed in the third, fourth, fifth and sixth condensing areas A3, A4, A5, and A6 respectively corresponding to the to third, fourth, fifth and sixth sub-pixels SP3, SP4, SP5 and SP6 at the observer's position OD. Thus, the control part 400 determines first, second and third division boundary portions CB1, CB2 and CB3 in the display area of the display panel 100. The first, second and third division boundary portions CB1, CB2 and CB3 may be determined by extension lines EL which connect an area, in which the observer's right-eye Reye is located, with boundary portions between the third, fourth, fifth and sixth condensing areas A3, A4, A5 and A6 at the OVD D.

The display area of the display panel 100 is divided into a first control area C1, a second control area C2, a third control area C3 and a fourth control area C4 by the first, second and third division boundary portion CB1, CB2 and CB3. The first control area C1 may correspond to the sub-pixels on display panel 100 that form the sixth condensing area A6, the second control area C2 may correspond to the sub-pixels that form the fifth condensing area A5, the third control area C3 may correspond to the sub-pixels that form the fourth condensing area A4 and the fourth control area C4 may correspond to the third condensing area A3.

Referring to FIG. 20B, the control part 400 may determine the set of pixels that display to the right eye, referred to herein as the right-eye sub-pixel, and the set of pixels that display to the left eye, referred to herein as the left-eye sub-pixel, respectively corresponding to the first, second, third and forth control areas C1, C2, C3 and C4 of display panel 100. For example, in the first control area C1, the first, sixth and fifth sub-pixels SP1, SP6 and SP5 are determined as the right-eye sub-pixel, and the second, third and fourth sub-pixels SP2, SP3 and SP4 are determined as the left-eye sub-pixel, based on the sixth condensing area A6. In the second control area C2, the sixth, fifth and fourth sub-pixels SP6, SP5 and SP4 are determined as the right-eye sub-pixel, and the third, second and first sub-pixels SP3, SP2 and SP1 are determined as the left-eye sub-pixel, based on the fifth condensing area A5. In the third control area C3, the fifth, fourth and third sub-pixels SP5, SP4 and SP3 are determined as the right-eye sub-pixel and the second, first and sixth sub-pixels SP2, SP1 and SP6 are determined as the left-eye sub-pixel, based on the fourth condensing area A4. In the fourth control area C4, the fourth, third and second sub-pixels SP4, SP3 and SP2 are determined as the right-eye sub-pixel, and the first, sixth and fifth sub-pixels SP1, SP6 and SP5 are determined as the left-eye sub-pixel, based on the third condensing area A3. That is, the left-eye sub-pixel is automatically determined by the right-eye sub-pixel.

As described above, the left-eye sub-pixel is determined according to the right-eye sub-pixel. Therefore, referring to left-eye luminance profiles shown in FIG. 20B, in a first area a1, the observer's left-eye Leye may observe the right-eye image displayed on the fourth sub-pixel SP4 which is determined as the right-eye sub-pixel. In addition, in second and third areas a2 and a3, the observer's left-eye Leye may observe the right-eye image displayed on the second sub-pixel SP2 which is determined as the right-eye sub-pixel. A crosstalk image may be observed in the first, second and third areas, although the 3D display apparatus displays the 3D image with no problem.

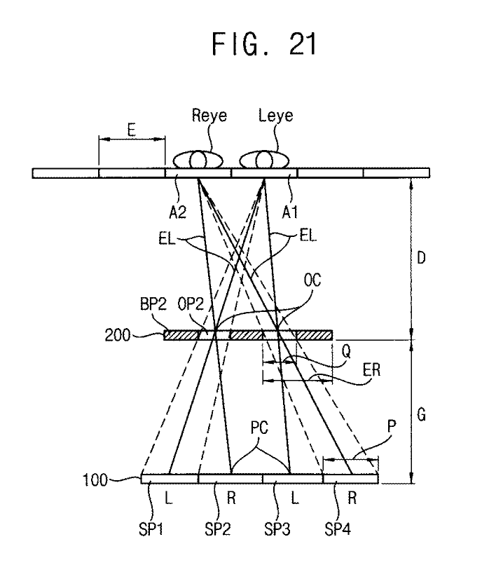

FIG. 21 is a conceptual diagram illustrating a method of displaying a 3D image in the landscape mode of the display apparatus as shown in FIG. 17.

Referring to FIGS. 17 and 21, according to the present exemplary embodiment, a method of displaying the 3D image in the landscape mode which is rotated by 90° from the portrait mode of the 3D display module having the area ratio of about 1:2 shown in FIG. 6, is explained.

As shown in FIG. 3B, in the landscape mode, a first sub-pixel SP1 of the display panel 100 displays a left-eye image L and a second sub-pixel SP2 of the display panel 100 displays a right-eye image R.

The active barrier panel 200 operates as a second opening OP2 and a second barrier BP2 by a second electrode part EP2 having a vertical structure in the landscape mode. An area ratio of the second opening OP2 to the second barrier BP2 may be about 1:1.

In the present exemplary embodiment, when a distance between an observer's two eyes is E, a width of the unit-pixel PU is P, a width of the second electrode part EP2 is ER, a width of the second opening OP2 is Q2, a gap between the active barrier panel 200 and the display panel 100 is G, and the distance of the observer from the active barrier panel 200 at the OVD is D, the following Equation 2 may be satisfied.

$$P ∷ G = E : D \\ D : {Q}_{2} = ( D + G ) : P \\ D = \frac{GE}{P} \\ {Q}_{2} = \frac{PD}{( D + G )} \\ ER = 2 {Q}_{2} \qquad \text{<Equation 2>}$$

The control part 400 determines a condensing area in the case in which D is the OVD. The condensing area is defined as an area in which an extension line EL connecting a central portion PC of the sub-pixel SP with a central portion OC of the second opening OP2 arrives at the OVD D. The length of the condensing area is determined by E in a horizontal direction.

Therefore, first and second condensing areas A1 and A2 may be determined respectively corresponding to first and second sub-pixels SP1 and SP2 at the OVD D.

The control part 400 controls the display driving part 500 to display the left-eye image L and the right-eye image R on the first and second sixth sub-pixels SP1 and SP2, based on the observer's position.

As shown in FIG. 21, when the observer's right-eye Reye is located in the second condensing area A2, the display driving part 500 displays the right-eye image R on the second sub-pixel SP2, and then the display driving part 500 displays the left-eye image L on the first sub-pixel SP1 corresponding to the remainder first condensing area A1.

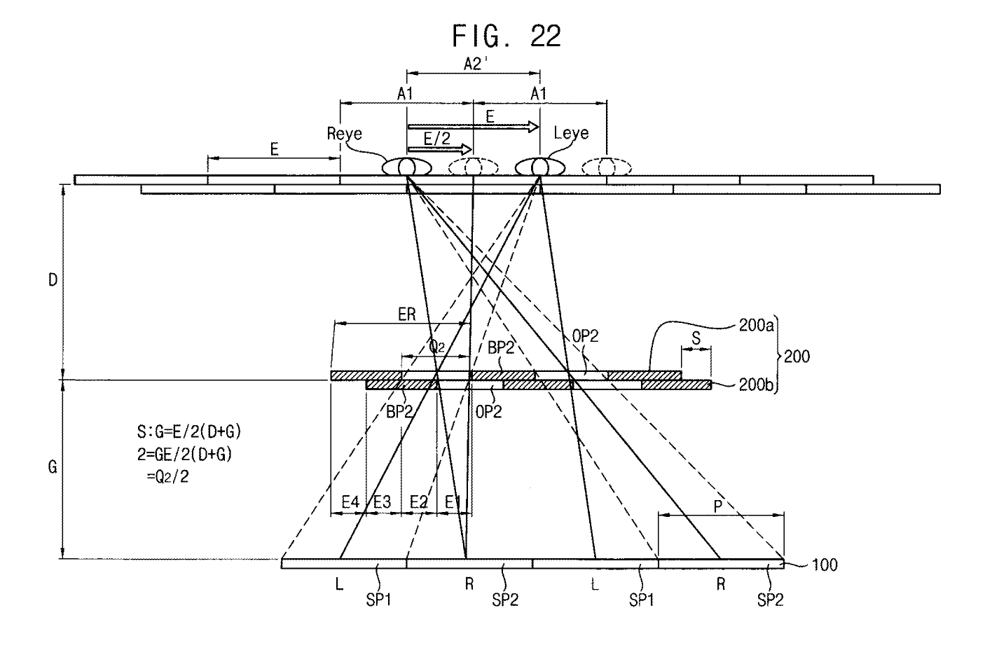

FIG. 22 is a conceptual diagram illustrating a method of displaying the 3D image according an observer's position within the OVD, in the landscape mode as shown in FIG. 21.

Referring to FIGS. 17 and 22, according to the present exemplary embodiment, the active barrier panel 200 may include a second electrode part EP2. The second electrode part EP2 may include first, second, third and fourth electrodes E1, E2, E3 and E4, and each of the first, second, third and fourth electrodes E1, E2, E3 and E4 may have an electrode width of ER/4. In the landscape mode, two electrodes of the first, second, third and fourth electrodes E1, E2, E3 and E4 may operate as a second opening OP2 and the remaining two electrodes of the first, second, third and fourth electrodes E1, E2, E3 and E4 may operate as the second barrier BP2.

The second electrode part EP2 operates as a first barrier-open condition 200a and a second barrier-open condition 200b according to the observer's position in the OVD D. The second barrier-open condition 200b is shifted by the electrode width of R/4 in a rightward direction or a leftward direction with respect to the first barrier-open condition 200a. For example, the first barrier-open condition 200a may include the first and second electrodes E1 and E2 which operate as the second opening OP2, and the third and fourth electrodes E3 and E4 which operate as the second barrier BP2. The second barrier-open condition 200b may include the second and third electrodes E2 and E3 which operate as the second opening OP2, and the first and fourth electrodes E1 and E4 which operate as the second barrier BP2. In other word, the second barrier-open condition 200b may be shifted by ½ times the width of the second opening electrode EO2 with respect to the first barrier-open condition 200a.

According to the present exemplary embodiment, the display panel 100 displays a left-eye image L and a right-eye image R on a first sub-pixel SP1 and a second sub-pixel SP2 adjacent to the first sub-pixel SP1 according to the first and second barrier-open condition 200a and 200b of the active barrier panel 200.

For example, the control part 400 determines the first barrier-open condition 200a as a standard condition. The observer's right-eye Reye may observe the right-eye image R displayed on the second sub-pixel SP2 through the first barrier-open condition 200a of the active barrier panel 200.

When the observer moves by a distance of E/2 with respect to the first barrier-open condition 200a that is the standard condition, the control part 400 controls the active barrier panel 200 to operate as the second barrier-open condition 200b. A center of the second opening OP2 in the second barrier-open condition 200b is nearer to a center of a condensing area A2′ in which the moved observer's right-eye Reye is located, rather than to a center of the second opening OP2 in the first barrier-open condition 200a. The control part 400 controls the display driving part 500 to display the right-eye image R on the second sub-pixel SP2 which condenses light into the condensing area A2′ through the second barrier-open condition 200b and display the left-eye image L on the first sub-pixel SP1 adjacent to the second sub-pixel SP2. When the observer moves by a distance of E/2 in the rightward direction with respect to the first barrier-open condition 200a that is the standard condition, the control part 400 processes an image using substantially the same method as an image processing method in the standard condition. Therefore, the first sub-pixel SP1 displays the left-eye image L and the second sub-pixel SP2 displays the right-eye image R.

Alternatively, when the observer moves by a distance of E in the rightward direction, the control part 400 controls the active barrier panel 200 to operate as the first barrier-open condition 200a. A center of the second opening OP2 in the first barrier-open condition 200a is nearer to a center of a condensing area A1 in which the moved observer's right-eye Reye is located, rather than to a center of the second opening OP2 in the second barrier-open condition 200b. The control part 400 controls the display driving part 500 to display the right-eye image R on the first sub-pixel SP1 which condenses light into the condensing area A1 through the first barrier-open condition 200a and display the left-eye image L on the second sub-pixel SP2 adjacent to the first sub-pixel SP1. When the observer moves by a distance of E in the rightward direction with respect to the first barrier-open condition 200a that is the standard condition, the control part 400 processes an image using an opposite method to the image processing method in the standard condition. Therefore, the first sub-pixel SP1 displays the right-eye image R and the second sub-pixel SP2 displays the left-eye image L.

As described above, according to the present exemplary embodiment, when the observer moves at the OVD D, the 3D image display apparatus may control the barrier-open condition of the active barrier panel 200 or the image displayed on the display panel 100 based on the observer's position, to display the 3D image.

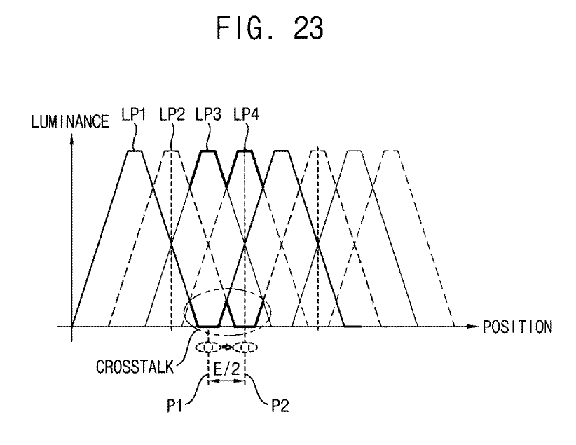

FIG. 23 is a graph diagram illustrating the luminance profiles of sub-pixels in the landscape mode within the OVD.

Referring to FIGS. 22 and 23, a first luminance profile LP1 is a luminance distribution of light emitted from the first sub-pixel SP1 when the active barrier panel 200 operates as the first barrier-open condition 200a, and a second luminance profile LP2 a luminance distribution of light emitted from the first sub-pixel SP1 when the active barrier panel 200 operates as the second barrier-open condition 200b.

A third luminance profile LP3 is a luminance distribution of light emitted from the second sub-pixel SP2 when the active barrier panel 200 operates as the first barrier-open condition 200a, and a fourth luminance profile LP4 a luminance distribution of light emitted from the second sub-pixel SP2 when the active barrier panel 200 operates as the second barrier-open condition 200b.

A crosstalk according to the observer's position may identify through the first to fourth luminance profiles LP1, LP2, LP3 and LP4.

Referring to the third and fourth luminance profiles LP3 and LP4, when the observer's right-eye Reye moves from a first position P1 to a second position P2, the active barrier panel 200 is changed from the first barrier-open condition 200a to the second barrier-open condition 200b so that the observer's right-eye Reye may observe the right-eye image displayed on the second sub-pixel SP2. In addition, referring to the first and second luminance profiles LP1 and LP2, the observer's right-eye Reye may observe the left-eye image of a low luminance displayed on the first sub-pixel SP1. As described above, the barrier-open condition of the active barrier panel 200 may be controlled based on the observer' position, so that the crosstalk of the 3D image may be improved.

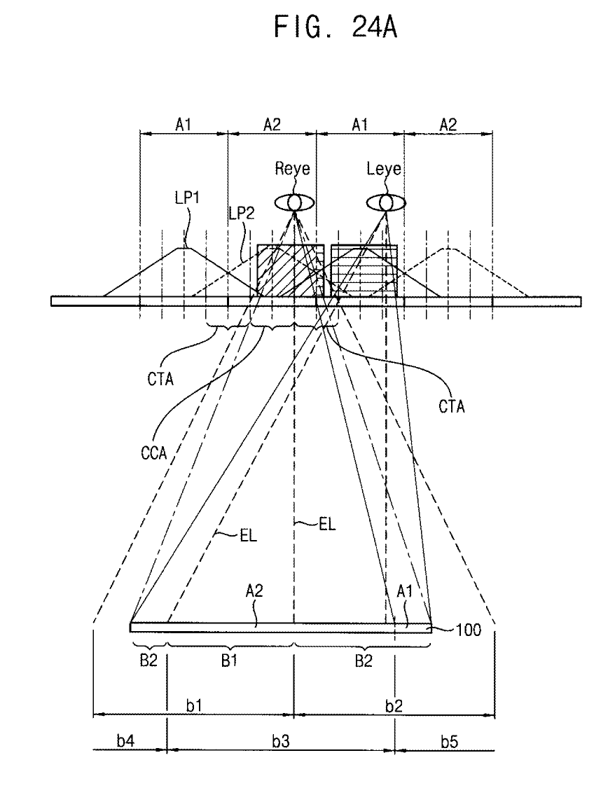

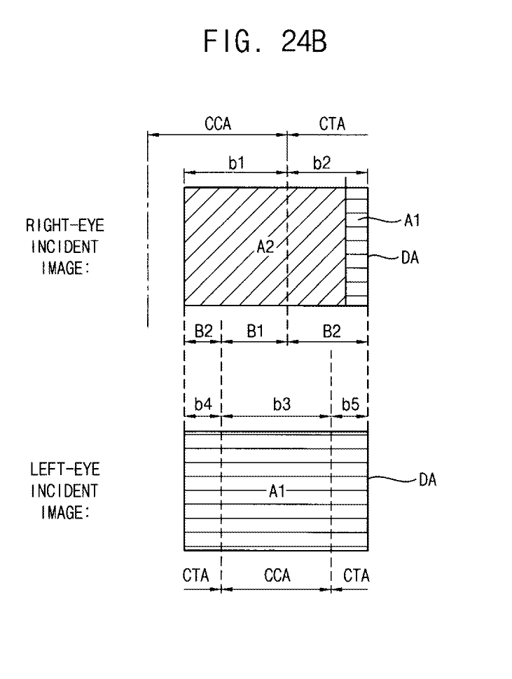

FIGS. 24A and 24b are conceptual diagrams illustrating a method of displaying the 3D image when the observer is located further away from the active barrier panel 200 than the OVD in the landscape mode as shown in FIG. 21.

Referring to FIGS. 17, 21 and 24a, the control part 400 controls the barrier driving part 600 to operate the active barrier panel 200 as one of the first and second barrier-open conditions 200a and 200b, which includes the second opening OP2 having a center being nearer to a center of a condensing area A2 in which the observer's right-eye is located.

The control part 400 divides the second condensing area A2 in which the observer's right-eye Reye is located into a central condensing area CCA and a crosstalk area CTA. The control part 400 divides the display area of the display panel 100 into a first area B1 corresponding to the central condensing area CCA and a second area B2 corresponding to the crosstalk area CTA by extension lines EL. The extension lines include an extension line which connects a boundary portion between the central condensing area CCA and the crosstalk area CTA with a center of an area in which the observer's right-eye Reye is located, and an extension line which connects a boundary portion between the central condensing area CCA and the crosstalk area CTA with a center of an area in which the observer's left-eye Leye is located.

The display driving part 500 displays the right-eye image R on the second sub-pixel SP2 corresponding to the second condensing area A2, and displays the left-eye image L on the first sub-pixel SP1 adjacent to the second sub-pixel SP2 in first area B1. The display driving part 500 displays a preset image on the first and second sub pixels SP1 and SP2 in the second area B2.

Referring to FIG. 24 B, a right-eye incident image, which is incident into the observer's right-eye is shown. The display area DA is divided into an area b1 corresponding to the central condensing area CCA and an area b2 corresponding to the crosstalk area CTA. The observer's right-eye Reye observes the right-eye image R on the area b1 and observes a crosstalk image mixed the left-eye image L and the right-eye image R on the area b2.

Referring to a left-eye incident image, which is incident into the observer's left-eye as shown in FIG. 24B, the display area DA is divided into an area b3 corresponding to the central condensing area CCA and an areas b4 and b5 corresponding to the crosstalk area CTA. The observer's left-eye observes the left-eye image L on the area b3 and observes a crosstalk image mixed the left-eye image L and the right-eye image R on the areas b4 and b5.

Therefore, the both of the observer's eyes may observe the 3D image on the first area B1 of the display area DA, and may observe the crosstalk image on the second area B2 of the display area DA.

According to the present exemplary embodiment, the display driving part 500 may display the preset image such as a 2D image, a black image, a warning image and so on, on the second area B2 observed the crosstalk image. The warning image may include a message that informs the observer that the observer's position is located too far away from the OVD. Therefore, a display quality of the 3D image may be improved.

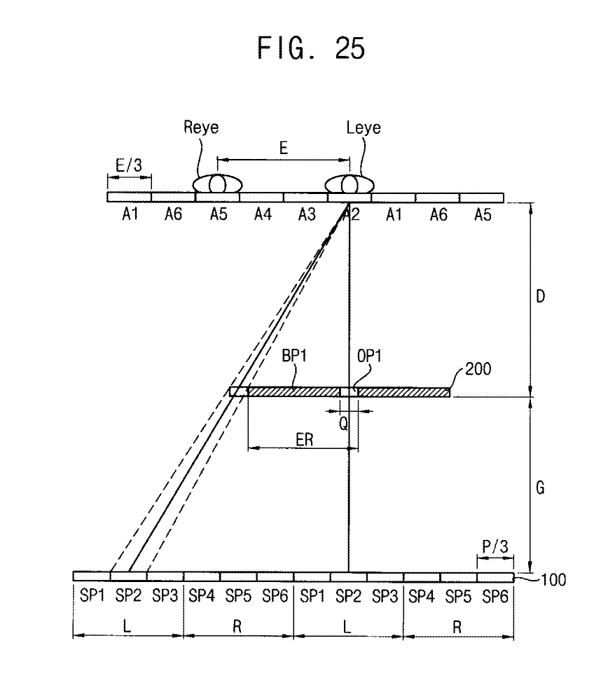

FIG. 25 is a conceptual diagram illustrating a method of displaying a 3D image in a portrait mode according to an exemplary embodiment.

Referring to FIG. 25, the method of displaying the 3D image in portrait mode using the 3D display module as shown in FIG. 10 is explained.

In the portrait mode, the unit-pixel PU of the display panel 100 may include the sub-pixels SP of red, green and blue. First, second and third sub-pixels SP1, SP2 and SP3 of the display panel 100 display a left-eye image L, and fourth, fifth and sixth sub-pixels SP4, SP5 and SP6 of the display panel 100 display a right-eye image R.

The active barrier panel 200 may include a first electrode part EP1 of a second step structure (1H/1V) and may operate as a first opening OP1 and a first barrier BP1. A ratio of the area of the first opening OP1 to the area of the first barrier BP1 may be about 1:5.

In the present exemplary embodiment, when a distance between observer's two eyes is E, a width of the unit-pixel PU is P, a width of the first electrode part EP1 is ER, a width of the first opening OP1 is Q, a gap between the active barrier panel 200 and the display panel 100 is G, and the distance of the observer from the active barrier panel 200 D is the OVD, the following Equation 3 may be satisfied.

$$\frac{P}{3} ∷ G = \frac{E}{3} : D \\ D : Q = ( D + G ) : \frac{P}{3} \\ D = \frac{GE}{P} \\ Q = \frac{PD}{3 ( D + G )} \\ ER = 6 Q \qquad \text{<Equation 3>}$$

The control part 400 determines a condensing area for the case in which D is the OVD. The condensing area is determined in an area in which an extension line connecting a central line through the sub-pixel SP with a central line of the first opening OP1 arrives at the OVD D. The width of the condensing area is determined by E/3 corresponding to the sub-pixel in a horizontal direction.

Therefore, first, second, third, fourth, fifth and sixth condensing areas A1, A2, A3, A4, A5 and A6 may be determined corresponding to first, second, third, fourth, fifth and sixth sub-pixels SP1, SP2, SP3, SP4, SP5 and SP6 at the OVD D.

The control part 400 controls the display driving part 500 to display the left-eye image L and the right-eye image R on the first, second, third, fourth, fifth and sixth sub-pixels SP1, SP2, SP3, SP4, SP5 and SP6, based on the observer's position.

For example, when the observer's right-eye Reye is located in the fifth condensing area A5, the display driving part 500 displays the right-eye image R on the fourth, fifth and sixth sub-pixels SP4, SP5 and SP6 respectively corresponding to the fifth condensing area A5 and the sixth and fourth condensing areas A6 and A4, which are adjacent the fifth condensing area A5. Then, the display driving part 500 displays the left-eye image L on the first, second and third sub-pixels SP1, SP2 and SP3 respectively corresponding to the remainder first, second and third condensing areas A1, A2 and A3.

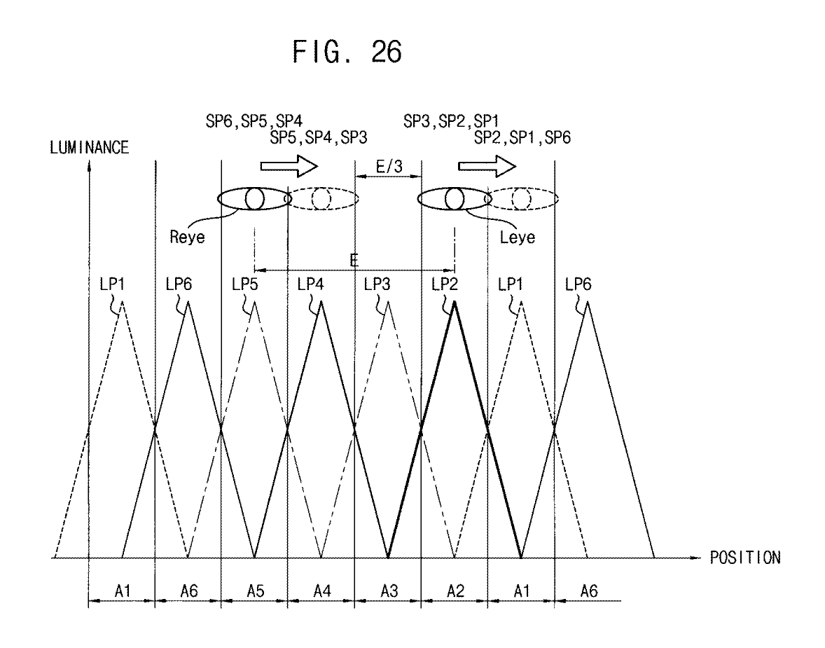

FIG. 26 is a conceptual diagram illustrating a method of displaying the 3D image according to an observer's position within the OVD, in the portrait mode as shown in FIG. 25.

Referring to FIGS. 25 and 26, the first, second, third, fourth, fifth and sixth sub-pixels SP1, SP2, SP3, SP4, SP5 and SP6 may have first, second, third, fourth, fifth and sixth luminance profiles LP1, LP2, LP3, LP4, LP5 and LP6 in the OVD D.

When the observer moves by a distance of E/3 in a rightward direction, as indicated by the arrows, the control part 400 analyzes a position of the observer's right-eye Reye which, in its new position, is located in the fourth condensing area A4, as indicated by dashed lines. The control part 400 controls the display driving part 500, so that the display driving part 500 displays the right-eye image R corresponding to the right-eye Reye on the third, fourth and fifth sub-pixels SP3, SP4 and SP5 corresponding to the fourth condensing area A4 and the fifth and third condensing areas A5 and A3 which are adjacent to the fourth condensing area A4. Then the display driving part 500 displays the left-eye image L corresponding to the left-eye Leye on the first, second and sixth sub-pixels SP1, SP2 and SP6 corresponding to the remainder first, second and sixth condensing areas A1, A2 and A6 except for the third, fourth and fifth condensing areas A3, A4 and A5.

As described above, according to the present exemplary embodiment, when the observer moves, staying within the OVD D, the 3D image display apparatus controls the left-eye and right-eye images L and R displayed on the sub-pixels SP based on the observer's position so that the 3D image may be displayed without a crosstalk.

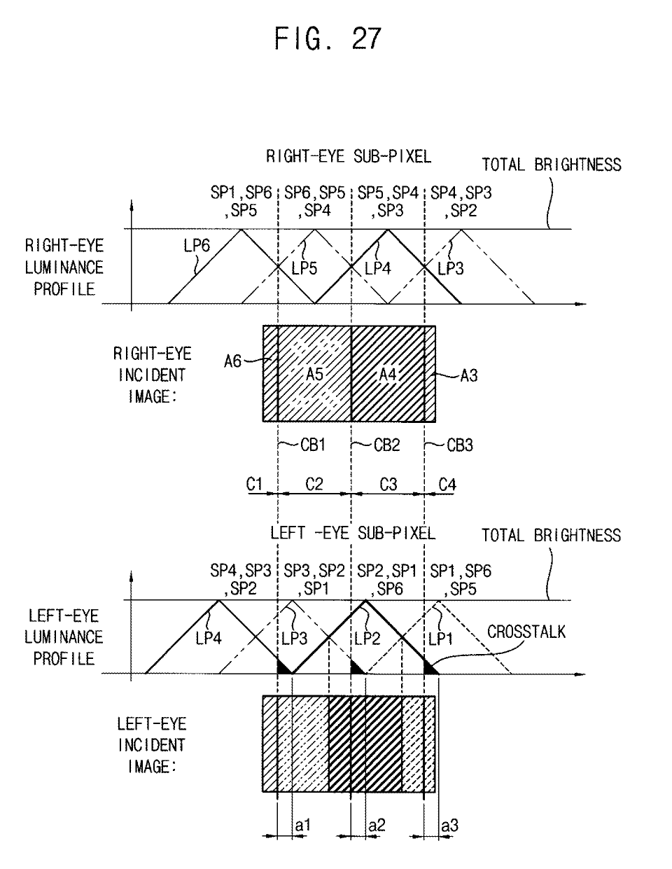

FIG. 27 is conceptual diagram illustrating a method of displaying the 3D image when the observer is located further away from the active barrier panel 200, outside of the OVD, in the portrait mode as shown in FIG. 25.

Referring to FIGS. 17, 25 and 27, as described above with respect to FIGS. 20A and 20B, the control part 400 determines first, second and third division boundary portion CB1, CB2 and CB3 in a display area of the display panel 100, based on the observer' position. The first, second and third division boundary portion CB1, CB2 and CB3 may be determined by extension lines which connect an area, in which the observer's right-eye Reye is located, with boundary portions between the first, second, third, fourth, fifth and sixth condensing areas A1, A2, A3, A4, A5 and A6, respectively corresponding to the first, second, third, fourth, fifth and sixth sub-pixels SP1, SP2, SP3, SP4, SP5 and SP6, distributed at the OVD D.

The display area of the display panel 100 is divided into a first control area C1, a second control area C2, a third control area C3 and a fourth control area C4 by the first, second and third division boundary portion CB1, CB2 and CB3.

The control part 400 may determine a right-eye sub-pixel (which, as previously explained, refers to the set of sup-pixels to display the right-eye image) and a left-eye sub-pixel (which, as previously explained, refers to the set of sup-pixels to display the left-eye image) for each of the first, second, third and forth control areas C1, C2, C3 and C4. For example, in the first control area C1, the first, sixth and fifth sub-pixels SP1, SP6 and SP5 are determined as the right-eye sub-pixel and the second, third and fourth sub-pixels SP2, SP3 and SP4 are determined as the left-eye sub-pixel. In the second control area C2, the sixth, fifth and fourth sub-pixels SP6, SP5 and SP4 are determined as the right-eye sub-pixel, and the third, second and first sub-pixels SP3, SP2 and SP1 are determined as the left-eye sub-pixel. In the third control area C3, the fifth, fourth and third sub-pixels SP5, SP4 and SP3 are determined as the right-eye sub-pixel and the second, first and sixth sub-pixels SP2, SP1 and SP6 are determined as the left-eye sub-pixel. In the fourth control area C4, the fourth, third and second sub-pixels SP4, SP3 and SP2 are determined as the right-eye sub-pixel and the first, sixth and fifth sub-pixels SP1, SP6 and SP5 are determined as the left-eye sub-pixel.

As described above, the left-eye sub-pixel is determined by the right-eye sub-pixel. Therefore, referring to left-eye luminance profiles corresponding to a left-eye incident image which is incident into the observer's left-eye shown in FIG. 27, the observer's left-eye Leye may observe the right-eye image displayed on the fourth sub-pixel SP4 which is determined as the right-eye sub-pixel in first area a1, displayed on the third sub-pixel SP3 which is determined as the right-eye sub-pixel in the second a2, and displayed on the second sub-pixel SP2 which is determined as the right-eye sub-pixel in the third a3. A crosstalk image may be observed on the first, second and third areas a1, a2 and a3 observed, although the 3D display apparatus may display the 3D image with no problem.

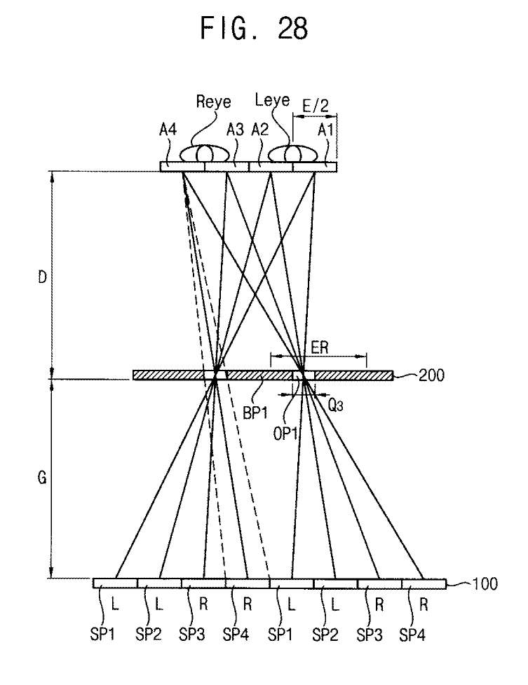

FIG. 28 is a conceptual diagram illustrating a method of displaying a 3D image in a portrait mode according to an exemplary embodiment.

Referring to FIGS. 17 and 28, the method of displaying the 3D image in the portrait mode using the 3D display module shown in FIG. 15, is explained.

The display panel 100 may include a plurality of unit pixels PU, and each of the unit pixels PU may include sub-pixels SP of red, green, blue and white R, G, B and W. The first and second sub-pixels SP1 and SP2 of the display panel 100 display the left-eye image L, and the third and fourth sub-pixels SP3 and SP4 displays the right-eye image R.

The active barrier panel 200 may include a first electrode part EP1 of a third step structure (1H/2V) and may operate as a first opening OP1 and a first barrier BP1. A ratio of the area of the first opening OP1 to the area of the first barrier BP1 may be about 1:3.

In the present exemplary embodiment, when a distance between observer's two eyes is E, a width of the unit-pixel PU is P, a width of the first electrode part EP1 is ER, a width of the first opening OP1 is Q3, a gap between the active barrier panel 200 and the display panel 100 is G, and a distance from the observer to the active barrier panel 200 D is the OVD, the following Equation 4 may be satisfied.

$$\frac{P}{2} ∷ G = \frac{E}{2} : D \\ D : {Q}_{3} = ( D + G ) : \frac{P}{2} \\ D = \frac{GE}{P} \\ {Q}_{3} = \frac{PD}{2 ( D + G )} \\ ER = 4 {Q}_{3} \qquad \text{<Equation 4>}$$

The control part 400 determines a condensing area in the case in which D is at the OVD. The condensing area is determined in an area in which an extension line connecting a central line of the sub-pixel SP and a central line of the first opening OP1 arrives at the OVD D, and the width of the condensing area is determined by E/2 respectively corresponding to the sub-pixels in a horizontal direction.

Therefore, first, second, third and fourth condensing areas A1, A2, A3 and A4 may be determined at the OVD D corresponding to first, second, third and fourth sub-pixels SP1, SP2, SP3 and SP4.

The control part 400 controls the display driving part 500 to display the left-eye image L and the right-eye image R on the first, second, third and fourth sub-pixels SP1, SP2, SP3 and SP4, based on the observer's position.

As shown in FIG. 28, when the observer's right-eye Reye is located in a boundary portion between third and fourth condensing areas A3 and A4, the display driving part 500 displays the right-eye image R on the third and fourth sub-pixels SP3 and SP4 respectively corresponding to the third and fourth condensing area A3 and A4, and then the display driving part 500 displays the left-eye image L on the first and second sub-pixels SP1 and SP2 respectively corresponding to the remainder first and second condensing areas A1 and A2.

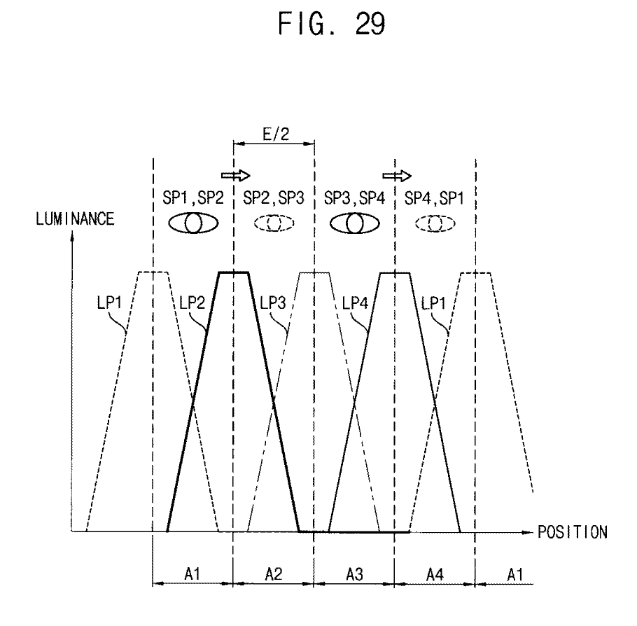

FIG. 29 is a conceptual diagram illustrating a method of displaying the 3D image according to an observer's position within the OVD, in the portrait mode as shown in FIG. 28.

Referring to FIGS. 28 and 29, the first, second, third, fourth, fifth and sixth sub-pixels SP1, SP2, SP3, SP4, SP5 and SP6 may have first, second, third, fourth, fifth and sixth luminance profiles LP1, LP2, LP3, LP4, LP5 and LP6 in the OVD D.

When the observer's right-eye Reye is located in the boundary portion between the third and fourth condensing areas A3 and A4, the observer's right-eye Reye may observe the right-eye image R displayed on the third and fourth sub-pixels SP3 and SP4 and the observer's left-eye Leye may observe the left-eye image L displayed on the first and second sub-pixels SP1 and SP2.

When the observer moves by a distance of E/2 in a rightward direction, the control part 400 analyzes a position of the observer's right-eye Reye which is located in the boundary area between the second and third condensing areas A2 and A3. The control part 400 controls the display driving part 500, so that the display driving part 500 displays the right-eye image R on the second and third sub-pixels SP2 and SP3, and then the display driving part 500 displays the left-eye image L on the remainder first and fourth sub-pixels SP1 and SP4.

As described above, according to the present exemplary embodiment, when the observer moves, staying within the OVD D, the 3D image display apparatus controls the left-eye and right-eye images displayed on the sub-pixels based on the observer' position so that the 3D image may be displayed.

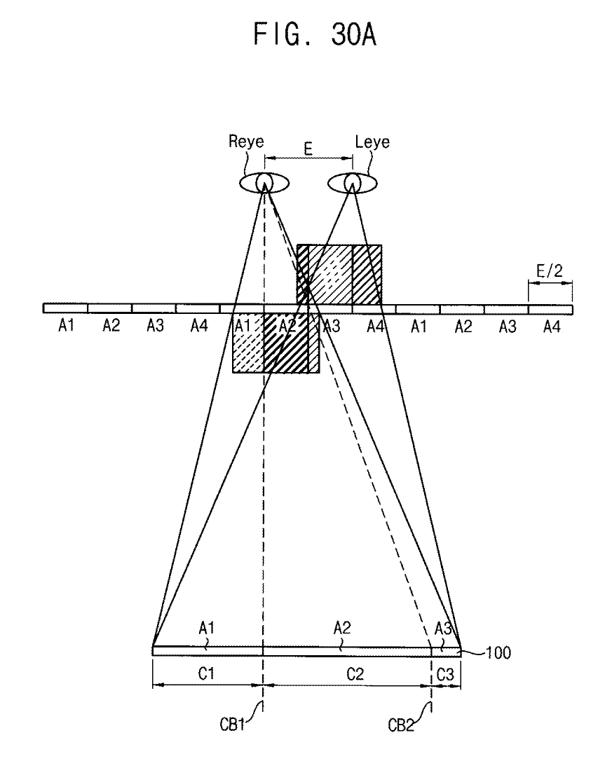

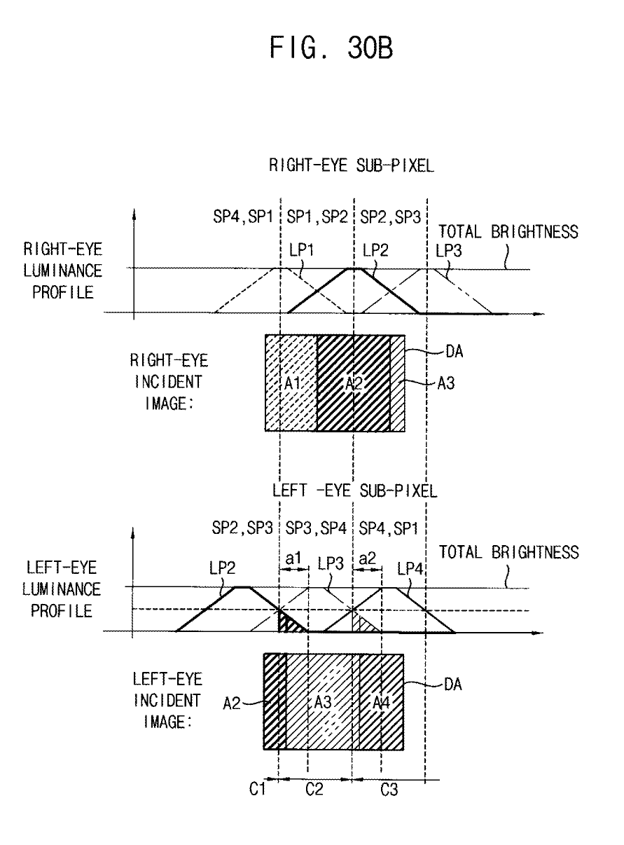

FIGS. 30A and 30B are conceptual diagrams illustrating a method of displaying the 3D image when the observer is located further away from the active barrier panel 200 than the OVD in the portrait mode as shown in FIG. 28.

Referring to FIGS. 17, 28 and 30A, the control part 400 determines first and second division boundary portions CB1 and CB2 in a display area DA of the display panel 100 by extension lines which connect a position of the observer' right-eye Reye and boundary portions the first to fourth condensing areas A1, A2, A3 and A4, distributed at the OVD D.

The display area DA of the display panel 100 is divided into a first control area C1, a second control area C2 and a third control area C3 by the first and second division boundary portion CB1 and CB2.

The control part 400 determines the first and fourth sub-pixels SP1 and SP4 as the right-eye sub-pixel, and the remainder second and third sub-pixels SP2 and SP3 as the left-eye sub-pixel, in the first control area C1. The control part 400 determines the first and second sub-pixels SP1 and SP2 as the right-eye sub-pixel, and the remainder third and fourth sub-pixels SP3 and SP4 as the left-eye sub-pixel, in the second area C2. The control part 400 determines the second and third sub-pixels SP2 and SP3 as the right-eye sub-pixel and the remainder first and fourth sub-pixels SP1 and SP4 as the left-eye sub-pixel, in the third control area C3. The left-eye sub-pixel is automatically determined by the right-eye sub-pixel.

As described above, the left-eye sub-pixel is determined according to the determined right-eye sub-pixel. Therefore, referring to a left-eye luminance profiles shown in FIG. 30B, the observer's left-eye Leye may observe the right-eye image displayed on the second sub-pixel SP2 which is determined as the right-eye sub-pixel in a first area a1. The observer's left-eye Leye may observe the right-eye image displayed on the third sub-pixel SP3 which is determined as the right-eye sub-pixel in a second area a2. A crosstalk image may be observed on the first and second areas a1 and a2, although the 3D display apparatus may display the 3D image with no problem.

Although not shown in figures, a method of displaying the 3D image in the landscape mode using the 3D display module shown in FIG. 15 may be substantially the same as those described referring to FIGS. 21 to 23, and repetitive detailed explanations are omitted. In other words, a method of displaying the 3D image in the landscape mode includes, controlling the barrier-open condition of the active barrier panel 200 or the left-eye and right-eye images displayed on the display panel 100 based on the observer's position when the observer moves, staying within the OVD. In addition, when the observer is located further away from the active barrier panel, outside of the OVD, the method of displaying the 3D image in the landscape mode includes dividing the condensing area in which the observer's one eye is located into the central condensing area and the crosstalk area observer, dividing the display panel into the first area corresponding to the central condensing area and the second area corresponding to the crosstalk area by the extension lines which connect boundary portions between the central condensing area and the crosstalk area with positions of the observer's two eyes, displaying the right-eye image on the sub-pixel corresponding to the condensing area and the left-eye image on adjacent sub-pixel in the first area and displaying the preset image on the sub-pixels in the second area. The preset image may include a 2D image, a black image and a warning image including a warning message.

According to the exemplary embodiments, the active barrier panel may be used in the 3D image display apparatus which operates in the portrait mode and in the landscape mode. The active barrier panel may prevent an abnormal color and a separate color, and may extend a viewing area in which the 3D image can be observed without crosstalk. In addition, the active barrier panel and the display panel may be controlled based on the observer's position, so that a display quality of the 3D image may be improved.

The foregoing is illustrative and is not to be construed as limiting. Although a few exemplary embodiments have been described, those skilled in the art will readily appreciate that many modifications are possible in the exemplary embodiments without materially departing from the novel teachings and advantages of the present invention. Accordingly, all such modifications are intended to be included within the scope of the present disclosure. In the claims, means-plus-function clauses are intended to cover the structures described herein as performing the recited function and not only structural equivalents but also equivalent structures. Therefore, it is to be understood that the foregoing is illustrative and is not to be construed as limited to the specific exemplary embodiments disclosed, and that modifications to the disclosed exemplary embodiments, as well as other exemplary embodiments, are intended to be included within the scope of the disclosure, including the appended claims.

What is claimed is:

1. An active barrier panel selectively transmitting light emitted from a plurality of sub-pixels included in a unit-pixel of a display panel, the active barrier panel comprising:
a first substrate including a first opening electrode configured to operate as a first opening transmitting the light and a first barrier electrode configured to operate as a first barrier blocking the light, the first opening electrode and the first barrier electrode each having a step structure;
a second substrate including a second opening electrode configured to operate as a second opening and crossing at a right angle to the first opening electrode, and a second barrier electrode configured to operate as a second barrier and crossing at a right angle to the first barrier electrode; and
a liquid crystal layer disposed between the first and second substrates.

2. The active barrier panel of claim 1, wherein a first voltage is applied to the first opening electrode and a second voltage is commonly applied to the first barrier electrode, the second opening electrode and the second barrier electrode in a portrait mode, and
the first voltage is applied to the second opening electrode and the second voltage is commonly applied to the second barrier electrode, the first opening electrode and the first barrier electrode in a landscape mode wherein a position of the display panel and active barrier panel is rotated as compared to the portrait mode.

3. The active barrier panel of claim 1, wherein the second opening electrode and the second barrier electrode are extended in a horizontal direction and a ratio of a width of the second opening electrode to a width of the second barrier electrode is about 1:1.

4. The active barrier panel of claim 1, wherein the unit-pixel includes three sub-pixels.

5. The active barrier panel of claim 3, wherein the unit-pixel includes four sub-pixels as a 2×2 structure.

6. The active barrier panel of claim 1, wherein a ratio of a width of the first opening electrode to a width of the first barrier electrode is about 1:1.

7. The active barrier panel of claim 6, wherein each of the first opening electrode and the first barrier electrode includes a 2H/1V step structure shape, wherein an area of the display panel covered by the first opening electrode and the first barrier electrode is shifted by two sub-pixels across each column along a horizontal direction and is shifted by one sub-pixel down each row along a vertical direction.

8. The active barrier panel of claim 6, wherein each of the first opening electrode and the first barrier electrode includes a 1H/1V step structure shape, wherein an area of the display panel covered by the first opening electrode and the first barrier electrode is shifted by one sub-pixel across each column along a horizontal direction and is shifted by one sub-pixel down each row along a vertical direction.

9. The active barrier panel of claim 6, wherein each of the first opening electrode and the first barrier electrode includes a 1H/2V step structure, wherein an area of the display panel covered by the first opening electrode and the first barrier electrode is shifted by one sub-pixel across each column along a horizontal direction and is shifted by two sub-pixels down each row along a vertical direction.

10. The active barrier panel of claim 1, wherein a ratio of a width of the first opening electrode to a width of the first barrier electrode is about 1:2.

11. The active barrier panel of claim 10, wherein each of the first opening electrode and the first barrier electrode includes a 2H/1V step structure, wherein an area of the display panel covered by the first opening electrode and the first barrier electrode is shifted by two sub-pixels across each column along a horizontal direction and is shifted by one sub-pixel down each row along a vertical direction.

12. The active barrier panel of claim 10, wherein each of the first opening electrode and the first barrier electrode includes a 1H/1V step structure, wherein an area of the display panel covered by the first opening electrode and the first barrier electrode is shifted by one sub-pixel across each column along a horizontal direction and is shifted by one sub-pixel down each row along a vertical direction.

13. The active barrier panel of claim 1, wherein a ratio of a width of the first opening electrode to a width of the first barrier electrode is about 1:3.

14. The active barrier panel of claim 13, wherein each of the first opening electrode and the first barrier electrode includes a 1H/2V step structure, wherein an area of the display panel covered by the first opening electrode and the first barrier electrode is shifted by one sub-pixel across each column along a horizontal direction and is shifted by two sub-pixels down each row along a vertical direction.

15. The active barrier panel of claim 1, wherein a ratio of a width of the first opening electrode to a width of the first barrier electrode is about 1:5.

16. The active barrier panel of claim 15, wherein each of the first opening electrode and the first barrier electrode includes a 1H/1V step structure, wherein an area of the display panel covered by the first opening electrode and the first barrier electrode is shifted by one sub-pixel across each column along a horizontal direction and is shifted by one sub-pixel down each row along a vertical direction.

17. The active barrier panel of claim 15, wherein each of the first opening electrode and the first barrier electrode includes a 2H/1V step structure, wherein an area of the display panel covered by the first opening electrode and the first barrier electrode is shifted by two sub-pixels across each column along a horizontal direction and is shifted by one sub-pixel down each row along a vertical direction.

18. A three-dimensional (“3D”) image display apparatus comprising;
a display panel including a plurality of unit pixels, each of the unit pixels including a plurality of sub-pixels and configured to display an image in a portrait mode or a landscape mode rotated from the portrait mode;
an active barrier panel including a first substrate which includes a first opening electrode and a first barrier electrode having a step structure, a second substrate which includes a second opening electrode crossing at a right angle to the first opening electrode and a second barrier electrode crossing at a right angle to the first barrier electrode, and a liquid crystal layer disposed between the first and second substrates; and
a control part configured to operate the first opening electrode as a first opening transmitting light and the first barrier electrode as a first barrier blocking the light in the portrait mode, and to operate the second opening electrode as a second opening and the second barrier electrode as a second barrier in the landscape mode.

19. The 3D image display apparatus of claim 18, further comprising a barrier driving part configured to drive the active barrier panel according to a control provided from the control part,
wherein the barrier driving part provides the first opening electrode with a first voltage and commonly provides the first barrier electrode, the second opening electrode and the second barrier electrode with a second voltage in a portrait mode, and
the barrier driving part provides the second opening electrode with the first voltage and commonly provides the second barrier electrode, the first opening electrode and the first barrier electrode with the second voltage in a landscape mode.

20. The 3D image display apparatus of claim 18, wherein the unit-pixel includes three sub-pixels.

21. The 3D image display apparatus of claim 18, wherein the unit-pixel includes four sub-pixels as a 2×2 structure.

22. The 3D image display apparatus of claim 18, wherein a ratio of a width of the first opening electrode to a width of the first barrier electrode is asymmetric to provide an asymmetric structure, and
a ratio of a width of the second opening electrode to a width of the second barrier electrode is symmetric to provide a symmetric structure, the second opening electrode and the second barrier electrode extended in a horizontal direction.

23. The 3D image display apparatus of claim 22, wherein the asymmetric structure includes about 1:2, about 1:3 and about 1:5, and the symmetric structure includes about 1:1.

24. The 3D image display apparatus of claim 22, further comprising a display driving part configured to display a first-eye image on n sub-pixels and to display a second-eye image on n sub-pixels (wherein, n is a natural number).

25. The 3D image display apparatus of claim 24, wherein the control part determines a condensing area at an optimum view distance (“OVD”) from the active barrier panel, the condensing area including the area at the OVD at which luminance from a set of corresponding sub-pixels can be observed, and determines n first-eye sub-pixels and n second-eye sub-pixels based on an observer's position and the condensing area in the portrait mode,
wherein the display driving part displays a first-eye image on the n first-eye sub-pixels and a second-eye image on the n second-eye sub-pixels under control of the control part.

26. The 3D image display apparatus of claim 25, wherein n is three.

27. The 3D image display apparatus of claim 25, wherein when the observer is located in the OVD,
the control part determines n sub-pixels respectively corresponding to n condensing areas adjacent to an area, in which an observer' first-eye is located, as the first-eye sub-pixel and determines n sub-pixels respectively corresponding to n condensing areas adjacent to an area, in which an observer' second-eye is located, as the second-eye sub-pixel,
wherein the display driving part respectively displays the first-eye and second-eye images on the determined first-eye and second-eye sub-pixels.

28. The 3D image display apparatus of claim 25, wherein when the observer is located further away from the active barrier panel than the OVD,
the control part determines a division boundary portion on the display panel, the division boundary portion being determined by an extension line connecting a center of an area in which an observer's first-eye is located with a boundary portion between the condensing areas, and determines a first-eye sub-pixel and a second-eye sub-pixel corresponding to a control area divided by the division boundary portion,
wherein the display driving part respectively displays the first-eye and second-eye images on the first-eye and second-eye sub-pixels in the control area.

29. The 3D image display apparatus of claim 24, wherein the control part controls the barrier driving part to operate as a first barrier-open condition and a second barrier-open condition according to an observer's position in the landscape mode, the second barrier-open condition shifted by ½ of a width of the second opening electrode from the first barrier-open condition that is a standard condition.

30. The 3D image display apparatus of claim 29, wherein the barrier driving part selectively operates the active barrier panel as one of the first and second barrier-open conditions according to the observer's position, and
the selected barrier-open condition including the second open part being nearer to a center of the condensing area adjacent to an area in which an observer's first-eye is located.

31. The 3D image display apparatus of claim 30, wherein when the observer is located in the OVD,
the control part controls the display driving part to display the first-eye image on n sub-pixels corresponding to n condensing areas adjacent to an area in which an observer's first-eye is located, and to display the second-eye image on n sub-pixels adjacent to the n sub-pixels displayed the first-eye image (wherein, n is a natural number).

32. The 3D image display apparatus of claim 30, wherein n is one.

33. The 3D image display apparatus of claim 30, wherein when the observer is located further away from to active barrier panel than the OVD,
the control part divides the condensing area in which an observer's first-eye is located into a central condensing area and a crosstalk area, and
divides the display panel into a first area corresponding to the central condensing area and a second area corresponding to the crosstalk area by an extension line connecting a boundary portion between the central condensing area and the crosstalk area with each of areas in which observer's both eyes are located,
wherein the display driving part displays the first-eye image on a sub-pixel corresponding to the condensing area in the first area, displays the second-eye image on a sub-pixel adjacent to the sub-pixel displayed the first-eye image, and displays a preset image on a sub-pixel in the second area.

34. The 3D image display apparatus of claim 30, wherein the preset image includes at least one of a two-dimensional (“2D”) image, a black image and a warning image.
